(19) United States
(12) Patent Application Publication
(10) Pub. No.: US 2026/0292049 A1
(43) Pub. Date: Sep. 24, 2026

(54) SIGNAL PROCESSING DEVICE, SIGNAL PROCESSING METHOD, AND PROGRAM

(71) Applicant: SONY GROUP CORPORATION, TOKYO (JP)

(72) Inventors: CHISATO KENMOCHI, TOKYO (JP); YUUKI MATSUMURA, TOKYO (JP); SHUICHIRO NISHIGORI, TOKYO (JP)

(21) Appl. No.: 19/100,594

(22) PCT Filed: Jul. 25, 2023
(86) PCT No.: PCT/JP2023/027190

§ 371 Date: Feb. 3, 2025

(30) Foreign Application Priority Data
Aug. 9, 2022 (JP) 2022-126836

(51) Int. Cl. H04L 69/22

(52) U.S. Cl. CPC H04L 69/22

(57) ABSTRACT

The present technology relates to a signal processing device, a signal processing method, and a program capable of reducing a processing delay time of bit rate adjustment of coded data. A signal processing device cuts out coded data of one frame including header information and main information from a head of the header information at a cutout size that is an integral multiple of a unit of cutout of N bytes, and adds a terminal identifier to a terminal end of the cutout data. The present technology can be applied to a real-time communication reproduction system.

### TECHNICAL FIELD

The present technology relates to a signal processing device, a signal processing method, and a program, and more particularly, to a signal processing device, a signal processing method, and a program capable of shortening a processing delay time of bit rate adjustment of coded data.

### BACKGROUND ART

When information such as video, audio, tactile sense, and vibration is transmitted, it is widely performed to adjust a compression rate, that is, a bit rate according to a situation of a communication path.

For example, Patent Document 1 and Patent Document 2 disclose a method for suppressing sound interruption by stepwisely adjusting a bit rate according to a situation of a communication path when audio data is transmitted.

In addition, Web Real-Time Communication (WebRTC) Simulcast is used as a method for performing communication at an optimum bit rate between a plurality of devices connected via the Internet.

Simulcast is realized by a mechanism in which a distribution side uploads a plurality of pieces of coded data coded at a plurality of bit rates to a relay server (SFU: Selective Forwarding Unit), and the relay server selects and transfers only coded data of an optimum bit rate according to a communication status with each terminal. That is, the feature of the SFU is that the received coded data is selected and transferred without being processed.

In addition, there is a method using a multipoint control unit (MCU) in which a relay server combines and distributes coded data received from each terminal. A feature of the MCU is that a plurality of pieces of received coded data is once decoded, coded again after synthesis, and transmitted to each terminal. That is, in the MCU, the bit rate is adjusted by re-encoding the decoded data.

Furthermore, there is a method of using SVC (Scalable Video Coding) in which cutout is performed at a boundary of hierarchies by providing hierarchies to an algorithm. A feature of the SVC is that data can be extracted and processed for each layer. That is, in the SVC, the bit rate is adjusted stepwise in units of layers.

### CITATION LIST

### Patent Document

Patent Document 1: Japanese Patent Application Laid-Open No. 2009-260931
Patent Document 2: Japanese Patent Application Laid-Open No. 2016-208215

### SUMMARY OF THE INVENTION

### Problems to be Solved by the Invention

The adjustment of these bit rates is mainly realized by encoding. That is, in order to adjust the bit rate of the coded data, it is necessary to decode the coded data once and code the coded data again so as to achieve the target bit rate, which is accompanied by occurrence of a processing delay time and an increase in processing load.

For example, in a case where content is compressed and recorded, in order to transmit the recorded content in a limited communication band, it is necessary to decode the content once and code the content again. Therefore, in a case where the content is compressed and recorded, a processing delay time occurs and a processing load also increases as compared with a case where the content is recorded in an uncompressed manner. Conversely, it is conceivable to record the content in an uncompressed manner, but in a case where the content is recorded in an uncompressed manner, it is necessary to secure a large recording capacity as compared with a case where the content is recorded in a compressed manner.

In a case where data received from the Internet is transmitted wirelessly with a narrow communication band such as Bluetooth (registered trademark), even if the same compression technology is used, it is necessary to decode the data once and code the data again so as to obtain a target bit rate.

The present technology has been made in view of such a situation, and an object thereof is to shorten a processing delay time of bit rate adjustment of coded data.

### Solutions to Problems

A signal processing device of one aspect of the present technology includes: a cutout unit that cuts out coded data of one frame including header information and main information from a head of the header information at a cutout size that is an integral multiple of a unit of cutout of N bytes; and a termination processing unit that adds a terminal identifier to a terminal end of the cutout data cut out by the cutout unit.

A signal processing device of another aspect of the present technology including a decoding unit that decodes cutout data transmitted after coded data of one frame including header information and main information is cut out at a cutout size that is an integral multiple of a unit of cutout of N bytes from a head of the header information while detecting a terminal identifier added to a terminal end of the cutout data on the basis of a head bit of the cutout data, and decodes information that cannot be decoded when the terminal identifier is detected as zero.

In one aspect of the present technology, coded data of one frame including header information and main information is cut out from a head of the header information at a cutout size that is an integral multiple of a unit of cutout of N bytes, and a terminal identifier is added to a terminal end of the cutout data.

In another aspect of the present technology, cutout data transmitted after coded data of one frame including header information and main information is cut out at a cutout size that is an integral multiple of a unit of cutout of N bytes from a head of the header information is decoded while detecting a terminal identifier added to a terminal end of the cutout data on the basis of a head bit of the cutout data, and information that cannot be decoded when the terminal identifier is detected is decoded as zero.

### BRIEF DESCRIPTION OF DRAWINGS

FIG. 1 is a diagram illustrating a configuration example of a real-time communication reproduction system according to a first embodiment of the present technology.

FIG. 2 is a diagram illustrating an example of a format of coded data of the present technology.

FIG. 3 is a diagram illustrating an example of initial information regarding cutout of coded data.

FIG. 4 is a block diagram illustrating a configuration example of a transmitter and a receiver.

FIG. 5 is a flowchart illustrating processing of the transmitter.

FIG. 6 is a flowchart illustrating cutout setting processing in step S11 in FIG. 5.

FIG. 7 is a flowchart illustrating processing of the receiver.

FIG. 8 is a flowchart illustrating decoding processing in step S56 in FIG. 7.

FIG. 9 is a block diagram illustrating a configuration example of a real-time communication reproduction system according to a second embodiment of the present technology.

FIG. 10 is a flowchart illustrating main processing of the transmitter.

FIG. 11 is a flowchart illustrating sub-processing of the transmitter.

FIG. 12 is a flowchart illustrating processing of the receiver.

FIG. 13 is a flowchart for explaining coded data writing processing in step S158 in FIG. 12.

FIG. 14 is a flowchart illustrating residual coded data writing processing in step S162 in FIG. 12.

FIG. 15 is a block diagram illustrating a configuration example of a real-time recording communication reproduction system according to a third embodiment of the present technology.

FIG. 16 is a flowchart illustrating processing of a coder.

FIG. 17 is a block diagram illustrating a configuration example of a real-time communication system according to a fourth embodiment of the present technology.

FIG. 18 is a block diagram illustrating a configuration example of a computer.

### MODE FOR CARRYING OUT THE INVENTION

Hereinafter, modes for carrying out the present technology will be described. The description will be given in the following order.
1. First Embodiment
2. Second Embodiment
3. Third Embodiment
4. Fourth Embodiment
5. Others

### 1. First Embodiment

### Configuration of Real-Time Communication Reproduction System

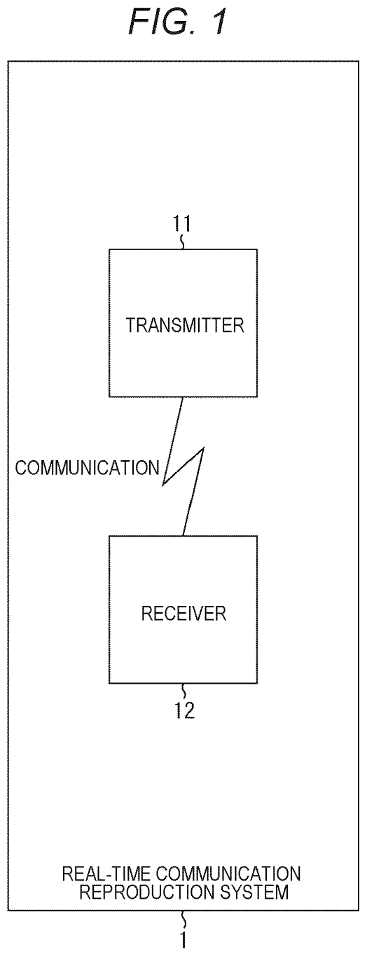

FIG. 1 is a diagram illustrating a configuration example of a real-time communication reproduction system according to a first embodiment of the present technology.

A real-time communication reproduction system 1 in FIG. 1 is configured to include a transmitter 11 and a receiver 12.

The transmitter 11 transmits at least part of audio coded data (hereinafter, simply referred to as coded data) recorded in a storage area (not illustrated) to the receiver 12.

The receiver 12 receives at least part of the coded data and reproduces the coded data in real time.

Note that the communication in the first embodiment may be long-distance communication via the Internet, short-distance communication such as Bluetooth, or intra-device communication. Furthermore, the data to be transmitted may be information such as video, audio, tactile sense, or vibration, but in the first embodiment, audio data such as music will be described as an example.

Furthermore, in the first embodiment, an instruction to start or stop reproduction is exchanged between the transmitter 11 and the receiver 12. The description “note that” in the first embodiment similarity applies to the following second to fourth embodiments.

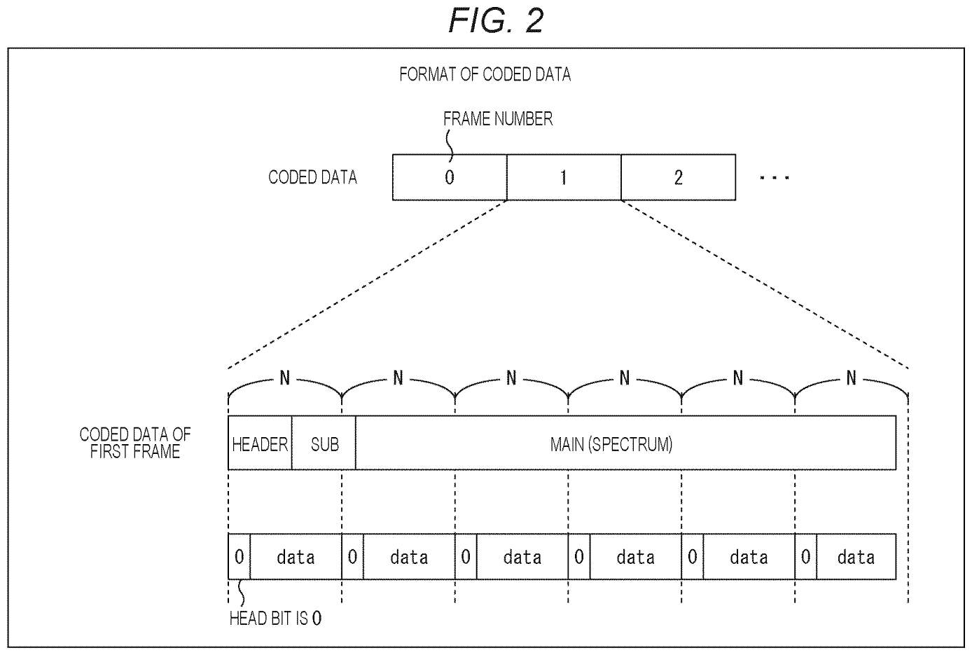

Furthermore, it is assumed that the transmitter 11 and the receiver 12 are ready to transmit coded data in the format of FIG. 2 to be described later and perform real-time reproduction. In preparation for real-time reproduction, for example, in the case of advanced audio distribution profile (A2DP) of Bluetooth, the type of audio codec used for communication, the sampling frequency, and the like may be determined. Note that the format of the coded data may be determined as one of the specifications of the audio codec in preparation for real-time reproduction.

### Format of Coded Data

FIG. 2 is a diagram illustrating an example of a format of coded data of the present technology.

The coded data in FIG. 2 is a data string obtained by encoding audio data in units of frames divided by a time length of, for example, 10 milliseconds.

The coded data of each frame includes header information, sub-information, and main information.

The header information includes, for example, information indicating a data size (hereinafter, the frame size) and a sampling frequency of the frame.

The sub-information includes, for example, outline information of the signal to be restored. The outline information of the signal to be restored is information that can restore or estimate the outline of the audio data, and is, for example, information for restoring a time waveform envelope, a frequency spectrum envelope, or the like of the audio data, or information such as a scale factor of each frequency band obtained by band division.

The main information includes information for restoring the fine structure of the audio data which is a signal to be restored, for example, a coded time waveform signal or a signal for each frequency bin.

In addition, in the main information, information is arranged in order from information with high importance. For example, in a case where the main information is audio data, the audio information is arranged from low-frequency audio information having high importance toward high-frequency audio information. For example, in a case where the main information is hierarchical encoding information such as SVC, the hierarchical encoding information is arranged in order from information of the first layer with high importance. Note that the arrangement is not limited to the example described above, and the information may be arranged so as to be arranged in order from information with low importance, or the information may be arranged so as not to be particularly associated with the importance.

Note that, in the following description, in order to simplify the description, it is assumed that each of the sub-information and the main information includes only the information regarding the frequency spectrum, but may include only the information regarding the time waveform or both the information regarding the frequency spectrum and the information regarding the time waveform.

Further, the coded data has a feature in which bits having a value of “0” appear at regular intervals. The interval (hereinafter, referred to as a head bit appearance interval) at which the bit having a value of “0” appears may be determined in advance in a standard or the like, for example. Furthermore, a recording area may be provided in the header information or the like, and information regarding the head bit appearance interval may be included in the recording area and transmitted from the transmission side to the reception side.

In FIG. 2, the head bit appearance interval is set to “N” bytes. Note that the unit is not limited to bytes. The head bit appearance interval N bytes is, for example, 20 bytes or 32 bytes. In the following examples, the head bit appearance interval N is described as 32 bytes unless otherwise specified, but other values may be used.

For the terminal end of the coded data, the data may be appropriately packed so that the data size becomes an integral multiple of the head bit appearance interval N bytes, but FIG. 2 illustrates an example of the coded data in a case where the data is not packed at the terminal end.

As described above, the coded data illustrated in FIG. 2 has a feature of being cut out and used in a size of an integral multiple of the head bit appearance interval N bytes.

Note that, in FIG. 2, the head bit appearance interval N bytes is always constant, but may be changed in the middle. For example, in the head bit appearance interval N bytes, the first 1 byte to 128 bytes may be set to 32 bytes, and the next 129 bytes to 256 bytes may be set to 64 bytes. Note that, in a case where the head bit appearance interval N bytes can be changed in the middle, for example, the head bit appearance interval N bytes may be defined in advance by a standard or the like, or the head bit appearance interval N bytes may be recorded in the header information and transmitted together with the coded data.

As a result, for example, in a case where data with high importance is arranged in front of the main information, data with high importance can be transmitted with higher priority, and data with low importance can be prevented from being transmitted.

### Initial Information on Cutout of Coded Data

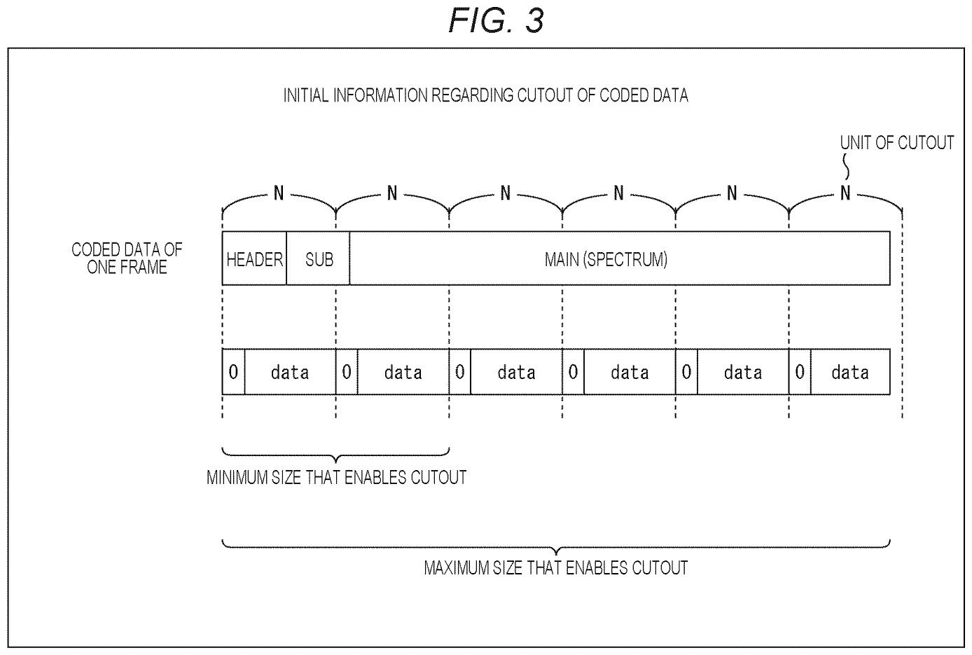

FIG. 3 is a diagram illustrating an example of initial information regarding cutout of coded data.

In FIG. 3, as an example of the initial information regarding the cutout of the coded data, a unit of cutout and a maximum size and a minimum size at the time of cutout are illustrated.

The unit of cutout is set to N bytes (=head bit appearance interval N (N bytes)), and the cutout size is set to an integral multiple of the unit of cutout (N bytes).

The minimum cutout size is an integer multiple of the unit of cutout, and is a minimum value of the size including all of the header information and the sub-information.

The maximum cutout size is an integral multiple of the unit of cutout, and is the minimum value of the size including all the coded data of one frame. In the case of FIG. 3, the minimum size is 2N bytes and the maximum size is 6N bytes.

### Configurations of Transmitter and Receiver

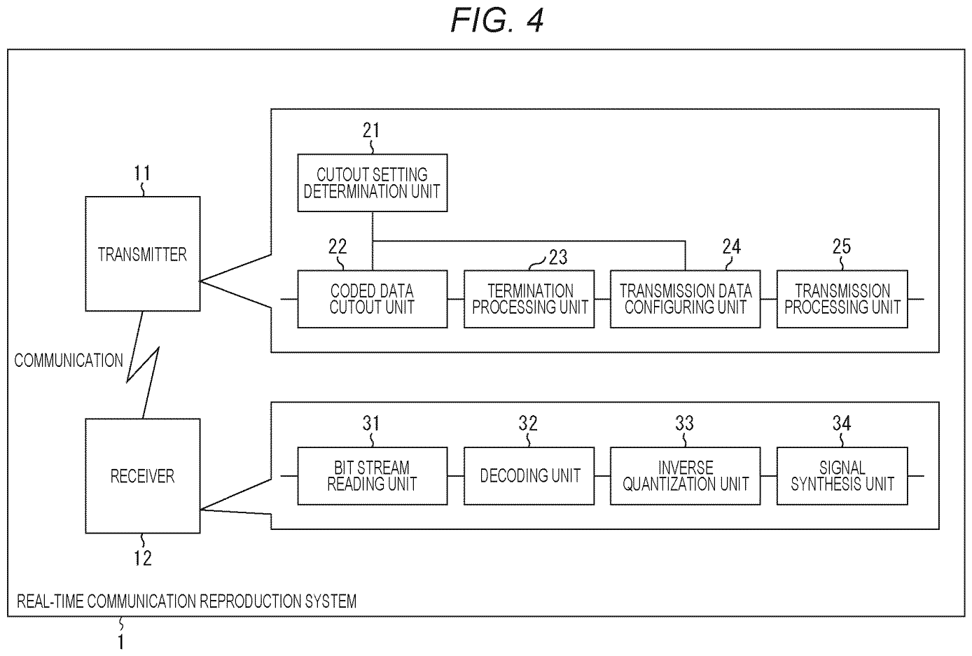

FIG. 4 is a block diagram illustrating a configuration example of the transmitter 11 and the receiver 12 in FIG. 1.

Upon receiving the reproduction start instruction, the transmitter 11 generates cutout setting information to be described later, cuts out coded data (cutout data) to be transmitted to the receiver 12 from the coded data of one frame according to the cutout setting information, and performs termination processing on the cutout coded data. The transmitter 11 collects the coded data subjected to the termination processing into a block of data (that is, the coded data having the format of FIG. 2) to be transmitted at a time, and transmits the data to the receiver 12.

The transmitter 11 in FIG. 4 is configured to include a cutout setting determination unit 21, a coded data cutout unit 22, a termination processing unit 23, a transmission data configuring unit 24, and a transmission processing unit 25.

The cutout setting determination unit 21 acquires information necessary for determining the cutout setting information in advance from a reception system (not illustrated), and determines a range of setting values that can be taken in the current reproduction.

When reproduction is started, the cutout setting determination unit 21 adjusts the cutout setting information on the basis of information such as a communication status intermittently received from the reception system, and outputs the adjusted cutout setting information to the coded data cutout unit 22 and the transmission data configuring unit 24.

The cutout setting information is configured to include, for example, a cutout size Cut_{SZ} of coded data and the number F_{NUM} of frames (frames put together in one packet) to be transmitted in one communication. Hereinafter, a pair of the number of frames and the cutout size will be referred to as a <F_{NUM}, Cut_{SZ}>.

The information received in advance by the cutout setting determination unit 21 includes, for example, information such as a maximum data size to be transmitted in one communication, information on a type and a size of a packet to be used for communication, the number of frames that can be put together in one packet, an allowable delay time, default cutout setting information, and a cutout specification (for example, initial information related to cutout in FIG. 3) related to coded data to be reproduced.

The range of setting values that can be taken by the cutout setting information is determined on the basis of information received in advance. For example, when the size of the packet is 200 bytes and the number of frames that can be put together in one packet is 3, if N is 32 bytes, <1, 2N to 6N (which can be taken by 2N, 3N, 4N, 5N, and 6N)>, <2, 2N and 3N>, and <3, 2N>are calculated. When the size of the packet is 150 bytes and the number of frames that can be put together in one packet is 3, <1, 2N to 4N>and <2, 2N>are calculated.

Note that, in a case where the allowable delay time is shorter than the time of two frames, only the above-described pattern in which F_{NUM} is 1 can be taken.

In addition, for the sake of simplicity of explanation, the data size added in the termination processing will not be particularly mentioned in the following description, but actually, the processing is performed in consideration of the data size.

The trend of information such as the communication status of the network, the processing load of the transmitter 11, and the resource vacancy information of the receiver 12 is analyzed, and the cutout setting information is adaptively determined on the basis of the analysis result. Alternatively, the cutout setting information is determined according to the setting selected by a user.

In a case where the cutout setting information is adaptively determined, for example, default cutout setting information is used as first cutout setting information, and the subsequent cutout setting information is determined from an estimated communication status or the like.

In the estimation of the communication status, for example, a quantity of transmission wait data in the transmission processing unit 25, a value of a moving average of the quantity, a retransmission ratio of data in recent seconds, an error rate, and the like are referred to. For example, in a case where all indicate high values, it is estimated that the communication status is bad. In a case where only the retransmission ratio indicates a high value, it is estimated that the communication status tends to deteriorate. In a case where only the data quantity indicates a high value, it is estimated that the communication status tends to improve. In a case where all indicate low values, it is estimated that the communication status is good.

The estimation time until the communication status is observed and estimated may be always constant. For example, the estimation time until the communication status is estimated may be adjusted such that the estimation time for estimating the deterioration tendency or the bad tendency is set to be short and the estimation time for estimating the improvement tendency or the good tendency is set to be long.

Furthermore, the processing load of the transmitter 11 is estimated with reference to, for example, a central processing unit (CPU) usage rate, a remaining battery amount, and the like. Therefore, the cutout setting information is adaptively determined on the basis of the CPU usage rate, the remaining battery amount, and the like.

In a case where the remaining battery amount is below 20%, for example, the cutout setting information may be limited such that the cutout setting information is set such that the number of frames to be transmitted at one time increases, or the selectable F_{NUM} of the cutout setting information is set to 3 or more, for example, in order to suppress the transmission power. Note that cutout setting information for suppressing power consumption may be separately prepared.

For example, in a case where the communication status is bad, in a case where the communication status tends to deteriorate, or in a case where the processing load is high, the cutout setting information is determined so as to lower the bit rate and increase the number of times of retransmission. Conversely, in a case where the communication status is good, or in a case where the communication status tends to be improved and the processing load is low, the cutout setting information is determined in a direction of increasing the bit rate.

For example, in a case where it is determined that the communication status tends to deteriorate in a case where the default cutout setting information is <1,4N>, the cutout setting information is updated to <2,3N>. Conversely, in a case where it is determined that the communication status is good, the cutout setting information is updated to <1,5N>.

Furthermore, in a case where the cutout setting information is determined according to the setting selected by a user, for example, options such as “sound quality priority” that maximizes the bit rate at the time of design and “connection priority” that prioritizes connection stability are prepared, and a relationship between the setting of the cutout setting information and the options to be presented to the user is determined in advance. Then, the cutout setting information is set according to an option selected by the user before or during communication.

The coded data cutout unit 22 reads only the coded data corresponding to Cut_{SZ} of the cutout setting information supplied from the cutout setting determination unit 21 among the coded data of one frame from the storage area, and outputs the coded data to the termination processing unit 23. That is, in the first embodiment, data other than the coded data corresponding to Cut_{SZ} of the cutout setting information is not read and is not transmitted to the receiver 12.

The termination processing unit 23 adds, for example, a terminal identifier which is data of 1 byte in which all bits are 1 to the coded data (cutout data) supplied from the coded data cutout unit 22, and outputs the resultant to the transmission data configuring unit 24.

The transmission data configuring unit 24 temporarily holds the coded data supplied from the termination processing unit 23 until the number in the coded data becomes the same as the number of F_{NUM} in the cutout setting information supplied from the cutout setting determination unit 21, and collectively outputs the coded data to the transmission processing unit 25 when the number of pieces of the coded data becomes the same.

However, as described above, since there is a possibility that F_{NUM} and Cut_{SZ} are updated in the middle, the timing of supply to the transmission processing unit 25 is changed according to the update contents. For example, in a case where F_{NUM} is 1, the transmission data configuring unit 24 immediately outputs the coded data to the transmission processing unit 25. In a case where F_{NUM} is 2, the transmission data configuring unit 24 receives coded data for two frames, concatenates the coded data for two frames into one, and outputs the resultant to the transmission processing unit 25.

Furthermore, in a case where F_{NUM} of 3 is updated to 2 and the prepared coded data is held in the state of F_{NUM} of 3, the transmission data configuring unit 24 immediately outputs the held coded data to the transmission processing unit 25 and newly starts preparation of the coded data of F_{NUM} of 2.

On the contrary, there may be a case where F_{NUM} of 3 is updated to 4, the prepared coded data is held in the state of F_{NUM} of 3, and the packet size exceeds when the newly concatenated coded data is concatenated to the prepared coded data. In this case, the transmission data configuring unit 24 immediately outputs the held coded data to the transmission processing unit 25, and newly starts preparation of the coded data with F_{NUM} of 4.

In a case where the packet size is not exceeded, the transmission data configuring unit 24 continues the preparation until F_{NUM} becomes 4, and outputs the coded data to the transmission processing unit 25 at timing when F_{NUM} becomes 4. The block of coded data supplied to the transmission processing unit 25 is transmitted to the receiver 12.

When receiving the block of coded data from the transmitter 11, the receiver 12 stores the block of coded data in a temporary storage area (hereinafter, referred to as a reception buffer) (not illustrated). When the stored coded data is accumulated by a certain number or a certain data size, the receiver 12 reads coded data for one frame from the receive buffer, decodes the coded data, inversely quantizes the coded data, synthesizes audio data, and reproduces the audio data with a speaker or the like by an output system (not illustrated).

The receiver 12 in FIG. 4 is configured to include a bit stream reading unit 31, a decoding unit 32, an inverse quantization unit 33, and a signal synthesis unit 34.

The bit stream reading unit 31 reads coded data for one frame from the receive buffer, and outputs the read coded data and information indicating a data size (=data size after cutout) not including the terminal identifier added by the termination processing unit 23 to the decoding unit 32.

In the header information of the coded data in the present exemplary embodiment, a frame size of one original frame (data size before cutout) is recorded. Note that the data size after cutout may be included in the header information. Hereinafter, a reading method in a case where the data size after cutout is not included in the header information will be described.

As described above, the coded data has a feature in that a bit having a value of “0” appears every N bytes of the unit of cutout (head bit appearance interval). In addition, by the termination processing after cutout, a terminal identifier with a value of “1” is added to the 1 bit at the head (hereinafter, also referred to as a head bit) of the coded data for each unit of cutout.

That is, the bit stream reading unit 31 determines whether or not the read data is data in one frame by confirming that the head bit is “0” every time N bytes are read. Therefore, when the head bit becomes “1”, the bit stream reading unit 31 can determine that it is the terminal identifier and can read to the head of the next frame. In the present embodiment, since the terminal identifier is one byte, one byte ahead is the head of the next frame.

By reading as described above, the cut-out coded data for one frame can be read without including the data size after the cut-out in the header information.

Note that it is sufficient that the head bit of the unit of cutout and the head bit of the terminal identifier can be identified, and the value of the head bit of the unit of cutout may be set to “1” and the value of the head bit of the terminal identifier may be set to “0”. In addition, both the head bit of the unit of cutout and the head bit of the terminal identifier may take a value or symbol other than “0” or “1”.

The decoding unit 32 decodes the coded data supplied from the bit stream reading unit 31 while skipping bits having a value of “0” every head bit appearance interval N, and outputs the decoded signal and the decoded range information (hereinafter, decoding range information) to the inverse quantization unit 33. For example, the decoding unit 32 processes up to information that can be correctly decoded within the range of the data size supplied from the bit stream reading unit 31, and outputs 0, for example, for the remaining information that cannot be decoded.

For example, in a case where the supplied data size is 100 bytes, 99 bytes and 4 bits from the head are decoded, and 7 bits are required for the next decoding, the decoding unit 32 determines that the bit depth required for decoding is insufficient, and thereafter, outputs 0. For example, in a case of decoding up to the 100th frequency spectrum is performed, 100 is output as the decoding range information.

The inverse quantization unit 33 inversely quantizes the decoded signal supplied from the decoding unit 32, and outputs the frequency spectrum obtained by the inverse quantization and the supplied decoding range information and sub-information such as Scale Factor of each frequency band to the signal synthesis unit 34. The inverse quantization is, for example, processing of returning the value of the frequency spectrum supplied using the Scale Factor information of each frequency band. For example, in a case where Scale Factor is 128 and the decoded signal is 0.75, the value after inverse quantization, that is, the value of the original frequency spectrum is obtained as 96 obtained by integrating these values.

The signal synthesis unit 34 synthesizes the audio signal using the decoding range information, the sub-information such as the scale factor information in the frequency band, and the frequency spectrum supplied from the inverse quantization unit 33, and outputs the synthesized audio signal to a processing block in a subsequent stage (not illustrated). The processing block in the subsequent stage performs audio signal processing such as equalizing on the supplied audio signal, and reproduces the audio signal by a speaker or the like.

In the synthesis of the audio signal, a frequency spectrum not included in the decoding range information is interpolated and then frequency-time converted to synthesize the audio signal. The interpolation in the frequency domain is performed, for example, by multiplying the frequency spectrum by the ratio of Scale Factor using the Scale Factor information of the frequency band not included in the decoding range information, the decoded frequency spectrum, and the Scale Factor information of the frequency band including the frequency spectrum. Alternatively, for example, a frequency spectrum not included in the decoding range information may be estimated from previously decoded information by artificial intelligence (AI) learned in advance. As described above, currently decoded information and previously decoded information may be used together.

Note that, in the present embodiment, as described above, in order to simplify the description, since the transmitted information is related to the frequency domain, the example of interpolation in the frequency domain has been described. However, information regarding the time waveform can also be transmitted. For example, in a case where envelope waveform information after time waveform is subjected to band division is transmitted, interpolation may be additionally performed after the frequency-time conversion.

### Processing of Transmitter

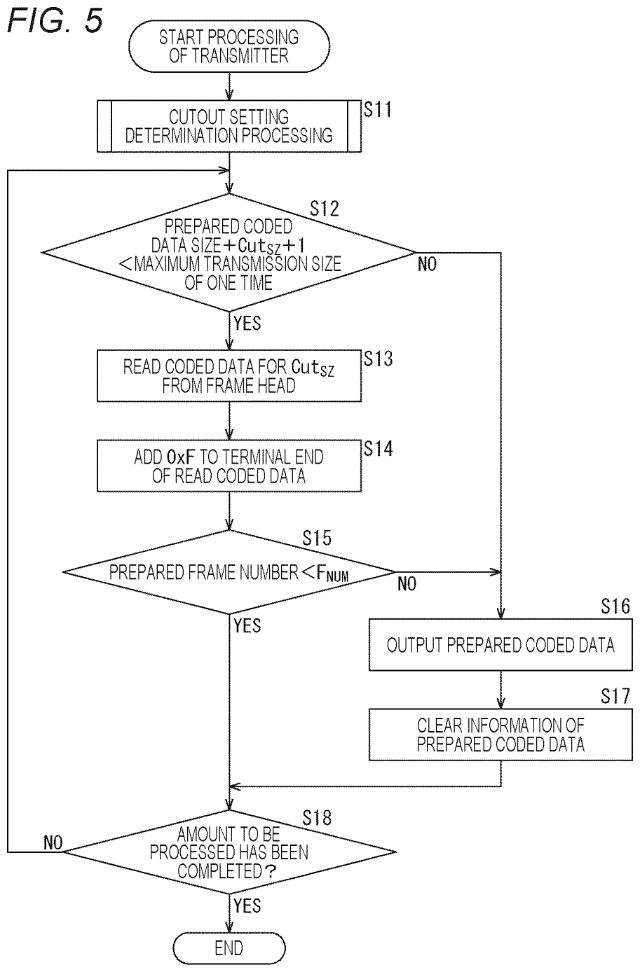

FIG. 5 is a flowchart illustrating processing of the transmitter 11.

In the transmitter 11, when reproduction is started, the processing illustrated in FIG. 5 is intermittently activated, and the number of frames according to the interval of the activation time is processed. For example, in a case where reproduction of coded data in which one frame is 10 milliseconds is started, and the processing illustrated in FIG. 5 is activated at intervals of about 50 milliseconds of 0 milliseconds, 48 milliseconds, 105 milliseconds, and 140 milliseconds, 5 frames are processed at each activation. In addition, the prepared coded data in the drawing is used by the coded data cutout unit 22 in order to simplify the description, and is cleared to 0 at the start of reproduction.

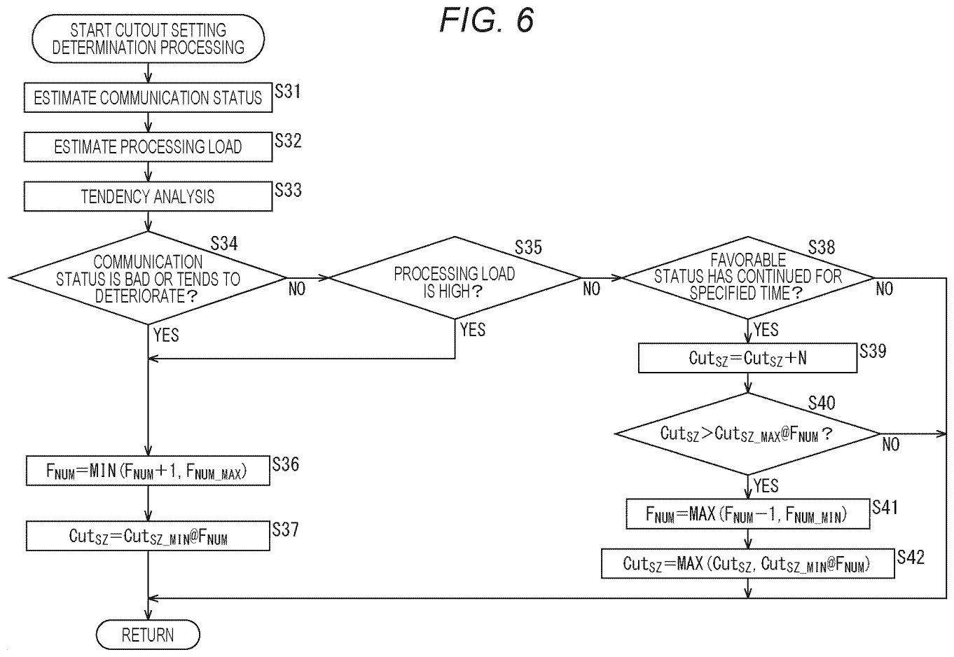

In step S11 of FIG. 5, the cutout setting determination unit 21 performs cutout setting determination processing. The cutout setting determination processing will be described later with reference to FIG. 6. By the processing of step S11, <FF_{NUM}, Cut_{SZ}>is calculated.

In step S12, the coded data cutout unit 22 determines whether or not the sum of the prepared coded data and the coded data for Cut_{SZ} thus calculated falls within the maximum transmission size of one time. Note that “+1” in the drawing indicates the data size of “0xFF” added in the termination processing.

In a case where it is determined in step S12 that the sum of the prepared coded data and the coded data for Cut_{SZ} thus calculated falls within the maximum transmission size of one time, the processing proceeds to step S13.

In step S13, the coded data cutout unit 22 reads the coded data for Cut_{SZ} thus calculated from the frame head, and writes the coded data at the end of the prepared coded data.

In step S14, the termination processing unit 23 writes “0xFF” at the terminal end of the prepared coded data.

In step S15, the transmission data configuring unit 24 determines whether or not the number of prepared frames, which is the number of frames written in the prepared coded data, is less than F_{NUM} thus calculated.

In a case where it is determined in step S15 that the number of prepared frames is not less than F_{NUM} thus calculated, that is, in a case where it is determined that the number of prepared frames becomes F_{NUM} thus calculated, the processing proceeds to step S16.

In addition, also in a case where it is determined in step S12 that the sum of the prepared coded data and the coded data for Cut_{SZ} thus calculated does not fall within the maximum transmission size of one time, the processing proceeds to step S16.

In step S16, the transmission data configuring unit 24 outputs the prepared coded data to the transmission processing unit 25.

In step S17, the transmission data configuring unit 24 clears the information of the prepared coded data. Thereafter, the processing proceeds to step S18.

On the other hand, also in a case where it is determined in step S15 that the number of prepared frames is less than F_{NUM} thus calculated, the processing proceeds to step S18.

In step S18, the transmission data configuring unit 24 determines whether or not an amount (the number of frames) to be processed at the current startup timing has been completed. In a case where it is determined in step S18 that the amount to be processed at the current startup timing has not been completed, the processing returns to step S12, and the subsequent processing is repeated.

In a case where it is determined in step S18 that the amount to be processed at the current startup timing has been completed, the processing of the transmitter 11 in FIG. 5 ends.

### Cutout Setting Determination Processing

FIG. 6 is a flowchart illustrating the cutout setting determination processing in step S11 of FIG. 5.

In step S31 of FIG. 6, the cutout setting determination unit 21 estimates (presumes) the communication status.

In step S32, the cutout setting determination unit 21 estimates (presumes) the processing load.

In step S33, the cutout setting determination unit 21 performs tendency analysis.

In step S34, the cutout setting determination unit 21 determines whether or not the communication status is bad or the communication status tends to deteriorate. In a case where it is determined in step S34 that the communication status is not bad and the communication status does not tend to deteriorate, the processing proceeds to step S35.

In step S35, the cutout setting determination unit 21 determines whether or not the processing load is high. In a case where it is determined in step S35 that the processing load is high, the processing proceeds to step S36.

In addition, also in a case where it is determined in step S34 that the communication status is bad or the communication status tends to deteriorate, the processing proceeds to step S36.

In step S36, the cutout setting determination unit 21 performs processing for improving the success rate of communication. In FIG. 6, for example, the number of frames transmitted in one transmission is increased. As a result, the number of times of retransmission at the time of failure can be increased. That is, when the number of frames transmitted in one transmission is increased, the transmission interval is widened, and the transmission interval is widened, so that time for retransmission can be increased. Specifically, assuming that one frame takes 1 second and one transmission takes 0.5 seconds, if the number of frames to be transmitted at one time is 5, the frames are transmitted at intervals of 5 seconds, and the time for retransmission is 4.5 seconds obtained by subtracting the first transmission time of 0.5 seconds from 5 seconds, which is 9 times in terms of the number of times. When this is increased by 1 frame, retransmission can be performed for 5.5 seconds, which is 11 times in terms of the number of times of retransmission.

Specifically, in step S36, the cutout setting determination unit 21 increases F_{NUM} by one. However, since the maximum value of F_{NUM} should not exceed F_{NUM_MAX} calculated at the time of initialization, the cutout setting determination unit 21 determines the final value by the MIN function taking the minimum value of 2 inputs (F_{NUM}=MIN(F_{NUM}+1, F_{NUM_MAX})).

In step S37, the cutout setting determination unit 21 sets Cut_{SZ} on the basis of F_{NUM} thus calculated. For example, Cut_{SZ_MIN}, which is the minimum value that Cut_{SZ} can take at the time of calculated F_{NUM}, is set as Cut_{SZ} (Cut_{SZ}=Cut_{SZ_MIN}@F_{NUM}).

For example, when <F_{NUM}, Cut_{SZ}> calculated at the time of initialization described above is <1, 2N to 6N>, <2, 2N or 3N>, and <3, 2N>, F_{NUM_MIN} is 1 and F_{NUM_MAX} is 3. For example, when F_{NUM} is 2, Cut_{SZ_MIN} is 2N, and Cut_{SZ_MAX} is 3N.

After step S37, the cutout setting determination processing in FIG. 6 ends.

On the other hand, in a case where it is determined in step S35 that the processing load is low, the processing proceeds to step S38.

In step S38, the cutout setting determination unit 21 determines whether or not a favorable status has continued for a specified time. In a case where it is determined in step S38 that the favorable status has continued for the specified time, the processing proceeds to step S39.

In step S39, the cutout setting determination unit 21 calculates a new Cut_{SZ} to be a current Cut_{SZ}+N (Cut_{SZ}=Cut_{SZ}+N).

In step S40, the cutout setting determination unit 21 determines whether or not Cut_{SZ} thus calculated exceeds the maximum Cut_{SZ} that can be taken by the current F_{NUM}, that is, Cut_{SZ_MAX} (Cut_{SZ}>Cut_{SZ_MAX}@F_{NUM}).

In a case where it is determined in step S40 that Cut_{SZ} thus calculated exceeds the maximum Cut_{SZ} that can be taken by the current F_{NUM}, that is, Cut_{SZ_MAX}, the processing proceeds to step S41.

In step S41, the cutout setting determination unit 21 updates the F_{NUM} to be decreased by one (F_{NUM}=MAX(F_{NUM}−1, F_{NUM_MIN})).

In step S42, the cutout setting determination unit 21 compares Cut_{SZ} with the minimum Cut_{SZ} that can be taken by F_{NUM} thus calculated, and sets the larger value as Cut_{SZ} (Cut_{SZ}=MAX(Cut_{SZ}, Cut_{SZ_MIN}@_{FNUM})). After step S42, the cutout setting determination processing in FIG. 6 ends.

On the other hand, in a case where it is determined in step S38 that the favorable status has not continued for the specified time, or in a case where it is determined in step S40 that Cut_{SZ} thus calculated does not exceed the maximum Cut_{SZ} that can be taken by the current F_{NUM}, that is, Cut_{SZ_MAX}, the cutout setting determination processing in FIG. 6 ends.

### Processing of Receiver

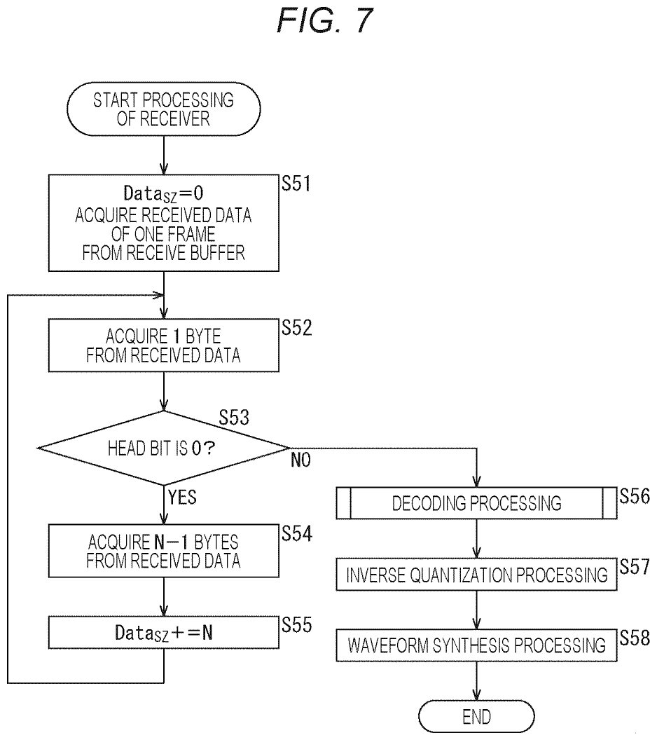

FIG. 7 is a flowchart illustrating processing of the receiver 12.

In the receiver 12, when reproduction is started, the processing illustrated in FIG. 7 is intermittently called to generate audio data for one frame.

In step S51 of FIG. 7, the bit stream reading unit 31 sets 0 to the data size (Data_{SZ}) after cutout (Data_{SZ}=0) and acquires received data of one frame from the receive buffer.

In step S52, the bit stream reading unit 31 acquires 1 byte from the received data.

In step S53, the bit stream reading unit 31 determines whether or not the head bit is 0. In a case where it is determined in step S53 that the head bit is 0, the processing proceeds to step S54.

In step S54, the bit stream reading unit 31 acquires N−1 bytes from the received data.

In step S55, the bit stream reading unit 31 updates Data_{SZ} by the acquired data size (Data_{SZ}+=N).

After step S55, the processing returns to step S52, and the subsequent processing is repeated.

On the other hand, in a case where it is determined in step S53 that the head bit is not 0, the processing proceeds to step S56.

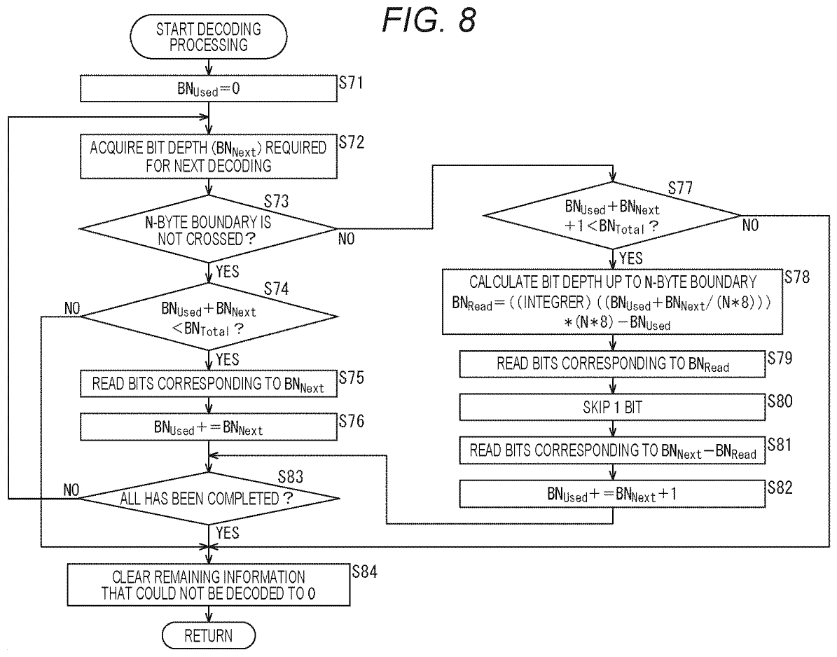

In step S56, the decoding unit 32 performs decoding processing. Details of the decoding processing will be described later with reference to FIG. 8.

In step S57, the inverse quantization unit 33 performs inverse quantization processing.

In step S58, the signal synthesis unit 34 performs waveform synthesis processing. The audio data is synthesized by the waveform synthesis processing and output to the subsequent stage. After step S58, the processing of the receiver 12 in FIG. 7 ends.

FIG. 8 is a flowchart illustrating a decoding processing in step S56 in FIG. 7.

Note that, in the decoding processing in FIG. 8, the number of used bits (BN_{Used}), the bit depth (BN_{Next}) necessary for decoding the next sample, and the bit conversion value (BN_{Total}=Data_{SZ}*8) of the supplied coded data size are compared, and the processing is continued only when there is the bit depth necessary for the decoding processing.

In step S71 of FIG. 8, the decoding unit 32 sets BN_{Used} to 0 (BN_{Used}=0).

In step S72, the decoding unit 32 acquires BN_{Next}, which is the bit depth required for the next decoding.

Note that BN_{Next} may be a value defined in advance in the standard, or information indicating the value of BN_{Next} may be recorded in the coded data. However, in the present embodiment, it is assumed that BN_{Next} is a value defined in advance in the standard in order to simplify the description. In addition, even in a case where the information indicating the value of BN_{Next} is recorded in the coded data, the reading can be performed in the similar procedure as reading bits corresponding to BN_{Next} described below.

In step S73, when the bits corresponding to BN_{Next} are read, the decoding unit 32 determines whether or not the unit of cutout (N-byte boundary) is not crossed. In a case where it is determined in step S73 that the N-byte boundary is not crossed, the processing proceeds to step S74.

In step S74, the decoding unit 32 determines whether BN_{Next} is not exceeded even if bits corresponding to BN_{Next} are further read (BN_{Used}+BN_{Next}<BN_{Total}). In a case where it is determined in step S74 that BN_{Next} is not exceeded even if the bits corresponding to BN_{Next} are further read, the processing proceeds to step S75.

In step S75, the decoding unit 32 actually reads the bits corresponding to BN_{Next} and decodes one value.

In step S76, the decoding unit 32 updates BN_{Used} by the bit depth corresponding to BN_{Used} (BN_{Used}+=BN_{Next}).

After Step S76, the Processing Proceeds to Step S83.

On the other hand, in step S73, in a case where, when bits corresponding to BN_{Next} are read, it is determined to cross the N-byte boundary, the processing proceeds to step S77.

In step S77, the decoding unit 32 determines whether or not 1 bit of 0 appearing every N bytes in addition to the bits corresponding to BN_{Next} exceeds BN_{Total} even if the 1 bit is further read (BN_{Used}+BN_{Next}+1<BN_{Total}).

In step S77, in a case where it is determined that BN_{Total} is not exceeded, the processing proceeds to step S78.

In step S78, the decoding unit 32 calculates the bit depth (BN_{Read}) up to the N-byte boundary.

The calculation is performed, for example, by obtaining a maximum value that does not exceed BN_{Used}+BN_{Next} with a multiple of N*8 and taking a difference from BN_{Used} as shown in the following formula (1).

$$\begin{matrix}[ Math . 1 ] & \\ {BN}_{Read} = {( ( Integerization ) ( ( {BN}_{used} + {BN}_{Next} ) / ( {N}^{⋆} 8 ) ) )}^{⋆} ( {N}^{⋆} 8 ) - {BN}_{used} & ( 1 )\end{matrix}$$

In step S79, the decoding unit 32 reads bits corresponding to calculated BN_{Read} thus calculated.

In step S80, the decoding unit 32 skips 1 bit in order to skip “0” appearing on the N-byte boundary.

In step S81, the decoding unit 32 further reads the remaining necessary bits BN_{Next}−BN_{Read}.

In step S82, the decoding unit 32 updates BN_{Used} with the total bit depth read (BN_{Used}+=BN_{Next}+1).

In step S83, the decoding unit 32 determines whether or not decoding of all values has been completed. In a case where it is determined in step S83 that decoding of all the values has not been completed, the processing returns to step S72, and the subsequent processing is repeated.

In a case where it is determined in step S83 that decoding of all the values has been completed, the processing proceeds to step S84.

In addition, also in a case where it is determined in step S77 that BN_{Total} is exceeded, the processing proceeds to step S84.

In step S84, the decoding unit 32 clears the remaining information that could not be decoded to 0. After step S84, the decoding processing in FIG. 8 ends.

As described above, in the first embodiment, the bit rate adjustment (change) can be realized by cutting out the coded data.

### 2. Second Embodiment

### Configuration of Real-Time Communication Reproduction System

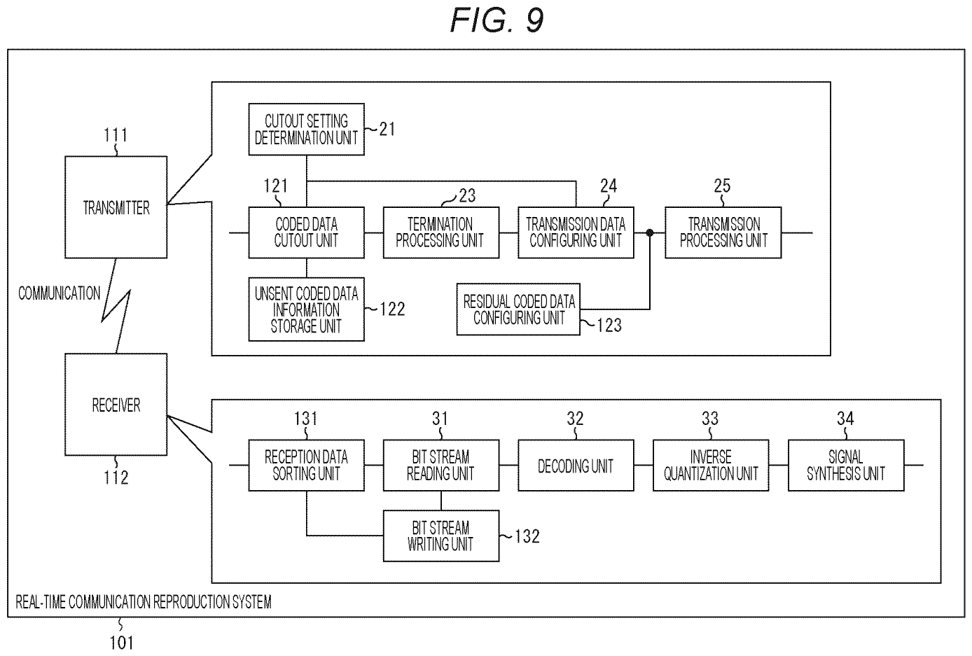

FIG. 9 is a diagram illustrating a configuration example of a real-time communication reproduction system according to a second embodiment of the present technology.

Note that, in the case of the first embodiment, the coded data remaining after being cut out (that is, the unsent coded data) is not transmitted and remains as it is, but on the transmission side of the second embodiment, the coded data remaining after being cut out is transmitted using the idle time of communication.

Further, on the reception side of the second embodiment, the coded data is reproduced in real time and recorded, so that the coded data can be reproduced later, and the coded data remaining after cutout, which is transmitted using the idle time of communication, is added (integrated) to the recorded coded data.

A real-time communication reproduction system 101 in FIG. 9 is configured to include a transmitter 111 and a receiver 112.

The transmitter 111 transmits, to the receiver 112, at least part of coded data in the format of FIG. 2 recorded in advance in the storage area. Furthermore, in a case where there is coded data that has not been sent (hereinafter, an unsent coded data) using the idle time of communication, the transmitter 111 generates residual coded data that is coded data remaining after cutout, and transmits the residual coded data to the receiver 112.

Specifically, when receiving the reproduction start instruction, the transmitter 111 generates cutout setting information, cuts out coded data for one frame in accordance with the cutout setting information, performs termination processing, collects the data into a block of data to be transmitted at a time, and outputs the data to the transmission processing unit 25. At that time, the information of the coded data cut out and subjected to the termination processing is stored as transmission history information.

Further, the transmitter 111 refers to the transmission history information, configures the residual coded data on the basis of the unsent coded data, and transmits the residual coded data to the receiver 112, for example, while the reproduction is stopped or during a gap time of main data communication.

Further, in a case where it is found that the transmission of the coded data has not been completed due to a cause such as a communication error, the transmitter 111 updates the history of the corresponding frame of the transmission history information, and leaves a history that the coded data that has been successfully transmitted is 0. This is because all the data is retransmitted even in a case where only part of the data is successfully transmitted, but only part of the data that cannot be transmitted may be retransmitted while leaving a history that only part of the data cannot be transmitted.

The receiver 112 receives at least part of the coded data and records the coded data while reproducing the coded data in real time. Further, the receiver 112 receives the residual coded data transmitted using the idle time of the communication, and records the received residual coded data by adding the received residual coded data to the recorded coded data. As a result, the quality of the recorded content can be made higher.

Specifically, in a case where receiving the data (hereinafter, referred to as received data) transmitted from the transmitter 111, the receiver 112 determines whether or not the data is residual coded data, and stores the coded data in the reception buffer when the data is not the residual coded data but the coded data. When a certain number or a certain data size of the stored coded data is accumulated, the receiver 112 reads the coded data for one frame from the reception buffer (temporary storage area). Then, the receiver 112 records the coded data in the storage area, and at the same time, synthesizes decoding, inverse quantization, and audio data, and reproduces the data with a speaker or the like by an output system.

Further, in a case where the received data is residual coded data, the receiver 112 records the residual coded data in addition to the coded data recorded in the storage area.

The storage area in which the coded data is recorded is, for example, a long-term recording device such as a hard disk drive. That is, thereafter, a user can reproduce the coded data at a desired timing without receiving the coded data from the transmitter 111 again.

Hereinafter, configurations of the transmitter 111 and the receiver 112 will be described. Note that, in FIG. 9, portions corresponding to those in FIG. 3 are denoted by corresponding reference numerals, and a detailed description thereof will be omitted.

The transmitter 111 in FIG. 9 is different from the transmitter 11 in FIG. 4 in that the coded data cutout unit 22 is replaced with a coded data cutout unit 121 and that an unsent coded data information storage unit 122 and a residual coded data configuring unit 123 are added.

That is, the transmitter 111 is configured to include a cutout setting determination unit 21, a termination processing unit 23, a transmission data configuring unit 24, the coded data cutout unit 121, the unsent coded data information storage unit 122, and the residual coded data configuring unit 123.

The coded data cutout unit 121 reads only the coded data corresponding to Cut_{SZ} of the cutout setting information supplied from the cutout setting determination unit 21 among the coded data of one frame from the storage area.

The coded data cutout unit 121 outputs the read coded data and the content ID which is index information capable of uniquely identifying the file of the reading source to the termination processing unit 23, and simultaneously outputs the content ID, the frame number, and Cut_{SZ} to the unsent coded data information storage unit 122. Note that one content ID corresponds to one or a plurality of frame numbers.

The unsent coded data information storage unit 122 pairs the supplied frame number and Cut_{SZ}, and stores them in a storage area (not illustrated) as transmission history information. For example, the transmission history information is recorded in a list format such that the transmission history information can be additionally written for each content ID. In this case, the unsent coded data information storage unit 122 records the transmission history information in a format including at least the frame number and Cut_{SZ} in the elements of the list.

The residual coded data configuring unit 123 is intermittently activated, refers to the above-described transmission history information, generates the residual coded data, for example, while the reproduction is stopped or during a gap time of the main data communication, and outputs the residual coded data to the transmission processing unit 25 when the unsent coded data exists and the main data communication is not performed.

Specifically, the residual coded data configuring unit 123 first refers to, for example, the oldest transmission history information, and reads coded data of a portion larger than Cut_{SZ} of the coded data of the corresponding frame number. The reading size is changed according to the communication status. For example, the reading size is set to N bytes in the case of the gap time of the main data communication, and is set to the size up to the end of the frame in the case where the reproduction is stopped.

Then, the residual coded data configuring unit 123 configures and transmits the residual coded data by including the header information, the content ID, the frame number, the reading position information (how many N bytes), and the reading size that can be distinguished from the transmission data configured by the transmission data configuring unit 24 in the read coded data. At the same time, the residual coded data configuring unit 123 also updates the transmission history information.

For example, as the header information for distinguishing the transmission data from the residual coded data, a data of 1 byte string in which the first bit is 1, for example, a value determined in advance in the standard, such as 0xFF, is used.

As an example of the update of the transmission history information, for example, in a case where Cut_{SZ} of the frame number 10 is 3 N bytes at the beginning, when the residual coded data configuring unit 123 reads data of N bytes, Cut_{SZ} of the frame number 10 is updated to 4 N bytes. Furthermore, in the case that all the pieces of coding information can be transmitted, for example, −1 may be set to Cut_{SZ} of the frame number, or the transmission history information of the frame number may be deleted so that the determination can easily be made. By updating the transmission history information as described above, it is possible to perform transmission without omission and duplication in order from the coded data of the frame having the smaller frame number.

Further, the residual coded data configuring unit 123 records the transmission history information in a list format, and sets, as an update rule, for example, moving the updated history to the end of the list and deleting the transmission history information of the frame in which all the unsent coded data can be transmitted from the list. Then, for example, the residual coded data configuring unit 123 sequentially transmits the frame number 10 in N bytes and the frame number 11 in N bytes in the minimum unit, so that the residual coded data can be transmitted on average for all the frames.

Note that, in the following description, an example in which data of N bytes is sent for each frame will be used for simplicity of description. In addition, since there is a case where N is not reached at the terminal end of the frame, the size of the residual coded data to be transmitted is transmitted together. Note that, in the second embodiment, the receiver has one configuration. However, a plurality of receivers may be provided. In this case, transmission history information is only required to be stored for each receiver.

The receiver 112 in FIG. 9 is different from the receiver 12 in FIG. 4 in that a received data sorting unit 131 and a bit stream writing unit 132 are added.

The received data sorting unit 131 analyzes the header information of the received data, determines whether or not the received data is the residual coded data, and outputs the residual coded data as it is to the bit stream writing unit 132 in a case where the received data is the residual coded data. In a case where the received data is not residual coded data, the received data sorting unit 131 stores the data in the reception buffer.

For example, in a case where the header information for determination is 1 byte of 0xFF described above, the received data sorting unit 131 determines whether or not the 1 byte at the head of the received data matches 0xFF. In a case of coincidence, the received data sorting unit 131 outputs the received data to the bit stream writing unit 132 as residual coded data.

The bit stream writing unit 132 writes out the coded data for one frame supplied from the bit stream reading unit 31 and the residual coded data supplied from the received data sorting unit 131 to the storage area.

First, a method of writing out coded data for one frame will be described.

The coded data for one frame is cut out on the transmitter 111 side and thus is partial data, but the bit stream writing unit 132 writes out the coded data while securing the size of the frame before being cut out at the writing destination.

That is, the bit stream writing unit 132 acquires the frame size before being cut out from the header information of the coded data, and writes out the coded data for one frame supplied first.

Next, the bit stream writing unit 132 writes out 0xFF until the written data size reaches the acquired frame size.

For example, in a case where the frame size written in the header of the coded data is 330 bytes and the size of the supplied coded data is 192 (6 N) bytes, the bit stream writing unit 132 secures a 330 byte area, records the supplied coded data in the first 192 bytes, and fills the remaining 138 bytes with 0xFF.

Further, coded data having the same content ID is written out to the same file, and in a case where the content IDs are different, coded data having the same content ID is written out to different files.

Note that the writing position is at the end of the file in a case where the coded data arrives consecutively. On the other hand, in a case where the frame numbers are not continuous due to a transmission error or the like, the bit stream writing unit 132 secures an area having the maximum size defined by the encoding method at the missing frame number position, and then writes out the received coded data to the continuation of the secured area.

For example, all pieces of information written at the missing frame number position may be set to 0xFF, or dedicated header information including a frame size and information indicating that frame interpolation is necessary may be written out, and the rest may be set to 0xFF.

Next, a method of writing out the residual coded data will be described.

The writing of the residual coded data is performed by first detecting the coded data of the frame having the frame number corresponding to the content ID transmitted together with the residual coded data, then looking at the head bit every N bytes, detecting the location where 1 appears, and overwriting the residual coded data over the last detected location.

For example, in a case where N bytes are supplied as the residual coded data for the frame (temporarily, frame number 10) written out as described above, the bit stream writing unit 132 opens the content file having the content ID recorded in the storage area corresponding to the frame number, that is, the file recording the coded data. Then, in the opened file, the bit stream writing unit 132 moves to the head of the coded data of the 10th frame, reads the head bit every N bytes from the head address, detects the address at which 1 appears, overwrites out the detected position with the residual coded data at the head, and saves the file.

By doing so, for example, in addition to the data of 6N bytes received first, N bytes corresponding to the residual coded data are written out, and the coded data of 7N bytes are written out to the storage area. As a result, the quality of the recorded content can be made higher before the user knows.

### Processing of Transmitter

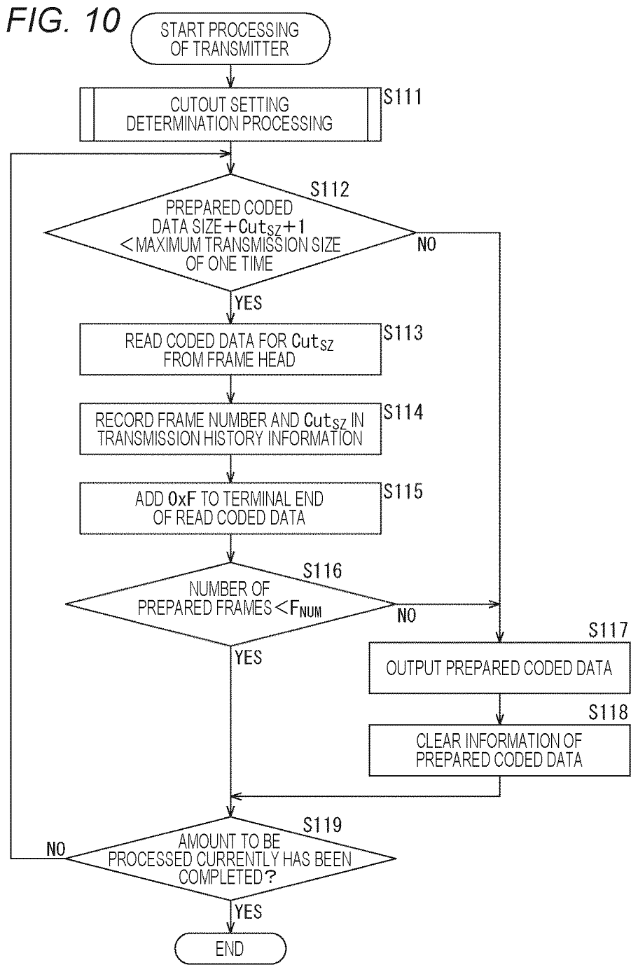

FIG. 10 is a flowchart illustrating main processing of the transmitter 111.

Note that the processing in steps S111 to S113 and S115 to S119 in FIG. 10 is similar to the processing in steps S11 to S18 in FIG. 5, and thus the description thereof will be omitted.

In step S113, the coded data cutout unit 121 reads the coded data for Cut_{SZ} thus calculated. At that time, the coded data cutout unit 121 outputs the content ID to the termination processing unit 23, and at the same time, outputs the content ID, the frame number, and Cut_{SZ} to the unsent coded data information storage unit 122.

In step S114, the unsent coded data information storage unit 122 pairs the frame number and Cut_{SZ} supplied from the coded data cutout unit 121 and records the pair in the transmission history information.

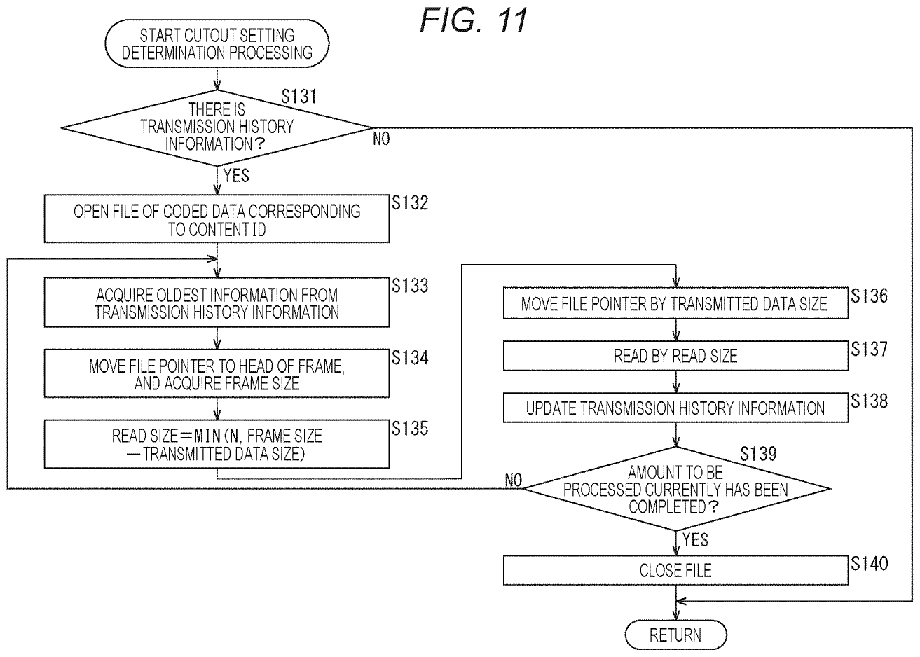

FIG. 11 is a flowchart illustrating the sub-processing of the transmitter 111.

The sub-processing in FIG. 11 is processing intermittently executed by the residual coded data configuring unit 123 in parallel with the main processing in FIG. 10 in the transmitter 111 of the second embodiment.

In step S131, the residual coded data configuring unit 123 determines whether or not there is the transmission history information. In a case where it is determined in step S131 that there is the transmission history information, the processing proceeds to step S132.

In step S132, the residual coded data configuring unit 123 opens the file of the coded data corresponding to the content ID of the transmission history information.

In step S133, the residual coded data configuring unit 123 acquires the oldest information (such as a frame number) in the transmission history information. For example, in a case where recording is performed in the form of a list, information at the head of the list is acquired.

In step S134, the residual coded data configuring unit 123 moves the file pointer to the head of the frame of the acquired frame number in the opened file, and acquires the frame size from the header.

In step S135, the residual coded data configuring unit 123 determines the read size with reference to the size of the remaining coded data which is the unsent coded data.

For example, in a case where acquiring the frame size of N bytes, the residual coded data configuring unit 123 compares the frame size with the size of the remaining coded data, and adopts the smaller value (read size=MIN(N, frame size-transmitted data size)). For example, if N is 32 bytes and the size of the remaining coded data is 40 bytes, 32 bytes is adopted, and if the size of the remaining coded data is 20 bytes, 20 bytes is adopted.

In step S136, the residual coded data configuring unit 123 moves the file pointer by the transmitted data size in the opened file. The residual coded data configuring unit 123 moves the file pointer to the position where the file pointer is actually read. For example, in a case where the transmitted size acquired from the transmission history information is 6 N, the residual coded data configuring unit 123 advances the position of the file pointer by 6 N bytes.

In step S137, the residual coded data configuring unit 123 reads the coded data by the read size calculated in step S135 from the position of the moved file pointer in the opened file.

In step S138, the residual coded data configuring unit 123 updates the transmission history information. For example, the contents of the data of the list referred to in step S133 are updated.

In step S139, the residual coded data configuring unit 123 determines whether or not the amount to be processed in the current execution has been completed. The amount to be processed in the current execution may be determined in advance as one frame or five frames in one processing, for example. Furthermore, the amount to be processed in the current execution may be dynamically determined, for example, according to the reproduction state, for example, only the N-byte residual coded data of one frame may be sent in one processing in the case of being reproduced, and all the residual coded data of one frame may be sent or the N-byte residual coded data of 10 frames may be sent in the case of being stopped.

In a case where it is determined in step S139 that the amount to be processed in the current execution has not been completed, the processing returns to step S133, and the subsequent processing is repeated.

In a case where it is determined in step S139 that the contents of the amount to be processed in the current execution have been completed, the processing proceeds to step S140.

In step S140, the residual coded data configuring unit 123 closes the file. After step S140, the sub-processing in FIG. 11 ends.

Also in a case where it is determined in step S131 that there is no transmission history information, the sub-processing in FIG. 11 ends.

### Processing of Receiver

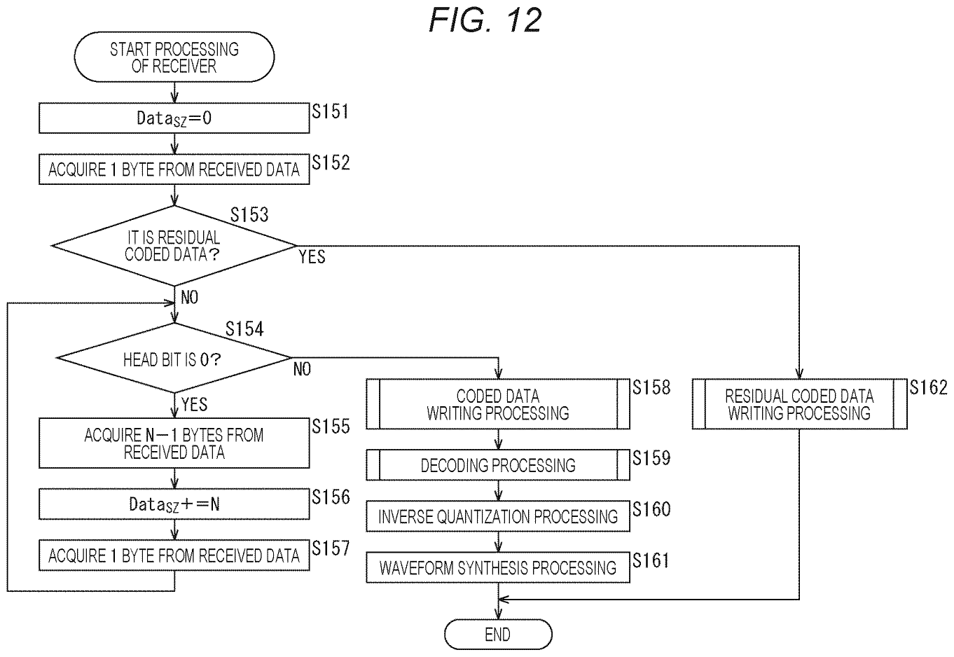

FIG. 12 is a flowchart illustrating processing of the receiver 112.

Note that the processing in steps S151, S152, S154 to S156, and S159 to S161 in FIG. 12 is basically similar to the processing in steps S51 to S58 in FIG. 7, and thus the description thereof will be omitted.

In addition, the processing in S157 is basically similar to that in step S152 (step S52 in FIG. 7), and this is obtained by changing the order in order to acquire the 1 byte at the head necessary in step S154, and is basically the same as the contents illustrated in FIG. 7.

In step S153 of FIG. 12, the received data sorting unit 131 determines whether or not the received data is residual coded data on the basis of 1 byte acquired in step S152. For example, it is determined whether or not 1 byte acquired in step S152 is 0xFF indicating header information for determination.

In a case where it is determined in step S153 that the received data is not residual coded data, the processing proceeds to step S154.

In step S154, the bit stream reading unit 31 determines whether or not the head bit is 0. In a case where it is determined in step S154 that the head bit is not 0, the processing proceeds to step S158. In this case, the bit stream reading unit 31 outputs the coded data for one frame to the bit stream writing unit 132.

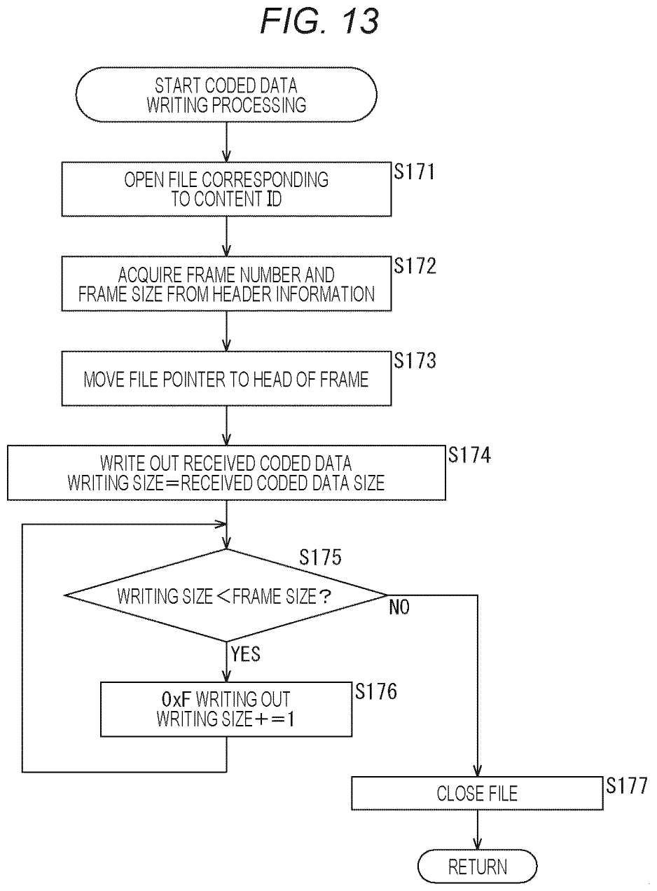

In step S158, the bit stream writing unit 132 writes out the coded data for one frame supplied from the bit stream reading unit 31. The coded data writing processing will be described later with reference to FIG. 13.

After the coded data is written out, the processing proceeds to step S159, and decoding processing is performed.

On the other hand, in a case where it is determined in step S153 that the data is the residual coded data, the processing proceeds to step S162. In this case, the received data sorting unit 131 outputs the residual coded data to the bit stream writing unit 132 as it is.

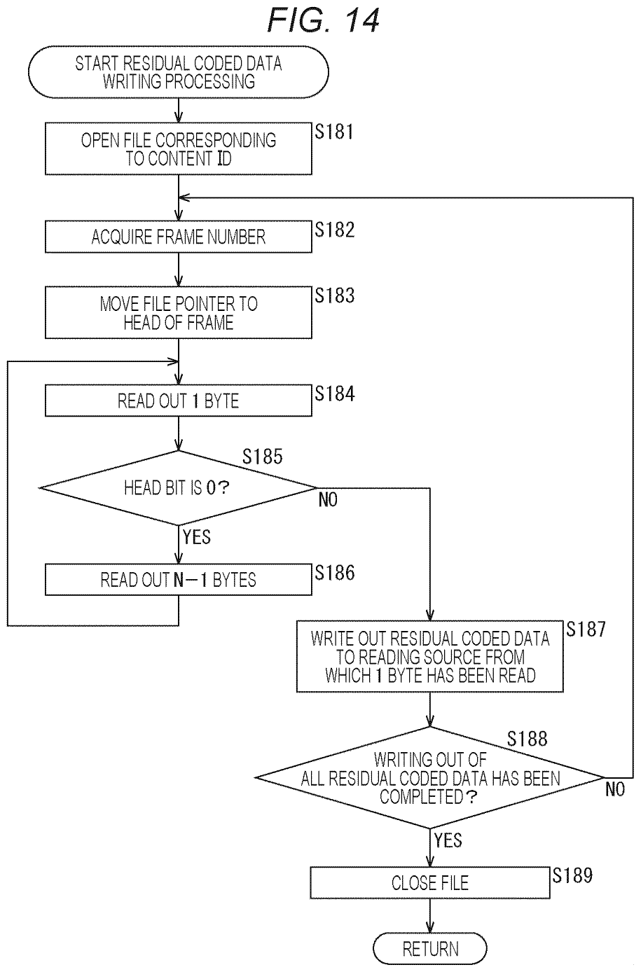

In step S162, the bit stream writing unit 132 writes out the residual coded data of one frame supplied from the bit stream reading unit 31. The residual coded data writing processing will be described later with reference to FIG. 14.

After the residual coded data is written out, the processing of the receiver 112 in FIG. 12 ends.

FIG. 13 is a flowchart illustrating the coded data writing processing in step S158 of FIG. 12.

In step S171, the bit stream writing unit 132 opens the file corresponding to the content ID. The file to be opened is a file in which coded data corresponding to the transmitted content ID is recorded, and is newly generated in a case where there is no corresponding file.

In step S172, the bit stream writing unit 132 acquires the frame number and the frame size from the header information of the received coded data.

In step S173, the bit stream writing unit 132 moves the file pointer to the head of the corresponding frame in the opened file. The movement destination is the end of the file in a case where the coded data is continuously transmitted. In addition, in a case where the frame numbers are not consecutive due to a transmission error or the like, as described above, the area having the maximum size defined by the encoding method is secured at the missing frame number position, and then the movement destination is next to the secured area.

In step S174, the bit stream writing unit 132 writes out the received coded data to a file, and sets the size of the actually written coded data to the writing size indicating the size of the written coded data (writing size=received coded data size).

In step S175, the bit stream writing unit 132 determines whether or not the writing size is smaller than the frame size acquired in step S172. In a case where it is determined in step S175 that the writing size is smaller than the frame size, the processing proceeds to step S176.

In step S176, the bit stream writing unit 132 writes out 0xFF every byte (writing size+=1). Note that, in the example of FIG. 13, writing out is performed every 1 byte, but writing out may be performed in a block of 8 bytes or 4 bytes after confirming the difference between the frame size and the writing size, and writing out may be performed in increments of 1 byte at the end.

After step S176, the processing returns to step S175, and the subsequent processing is repeated.

In a case where it is determined in step S175 that the writing size is larger than the frame size, the processing proceeds to step S177.

In step S177, the bit stream writing unit 132 closes the file.

After step S177, the coded data writing processing in FIG. 13 ends.

FIG. 14 is a flowchart illustrating the residual coded data writing processing in step S162 of FIG. 12.

In step S181, the bit stream writing unit 132 opens the file corresponding to the content ID. The file to be opened is a file in which coded data corresponding to the transmitted content ID is recorded, and as described above, in a case where there is no corresponding file when the coded data is written out, the file is generated in step S171 of FIG. 13 described above.

In step S182, the bit stream writing unit 132 acquires the frame number of the received residual coded data.

In step S183, the bit stream writing unit 132 moves the file pointer to the position where the coded data of the frame number acquired in step S182 is recorded on the file, for example, the head of the frame of the corresponding frame number. For the movement, for example, a method of referring to the frame size of the header information of each frame and skipping each frame until the frame is reached is used.

In step S184, the bit stream writing unit 132 reads 1 byte of coded data that has already been written out.

In step S185, the bit stream writing unit 132 determines whether or not the head bit is 0. In a case where it is determined that the head bit is 0, the processing proceeds to step S186.

In step S186, the bit stream writing unit 132 reads N−1 byte of coded data that has already been written out. After step S186, the processing returns to step S184, and the subsequent processing is repeated.

That is, in steps S184 to S186, the head bit is checked every N bytes in the already written coded data, and a position that is not 0 is detected.

In a case where it is determined in step S185 that the head bit is not 0, the processing proceeds to step S187.

In step S187, the bit stream writing unit 132 writes out the residual coded data to the reading source from which 1 byte has been read. That is, in step S187, the residual coded data is written out from the 1-byte area in which the head bit is determined not to be 0. The size to be written out can be acquired by size information sent together.

In step S188, the bit stream writing unit 132 determines whether or not writing out of all the residual coded data has been completed. In a case where it is determined in step S188 that writing out of all the residual coded data has not yet been completed, the processing returns to step S182, and the subsequent processing is repeated.

In a case where it is determined in step S188 that writing out of all the residual coded data has been completed, the processing proceeds to step S189.

In step S189, the bit stream writing unit 132 closes the file opened for writing out. After step S189, the residual coded data writing processing in FIG. 14 ends.

Note that, in the second embodiment, the case where the bit stream writing unit 132 receives the coded data from the bit stream reading unit 31 has been described as an example, but the bit stream writing unit 132 may be configured to always receive the coded data from the received data sorting unit 131 and write out the coded data to the storage area. In this case, functions necessary for the bit stream writing unit 132 are moved from the bit stream reading unit 31 and installed.

### 3. Third Embodiment

### Configuration of Real-Time Recording Communication Reproduction System

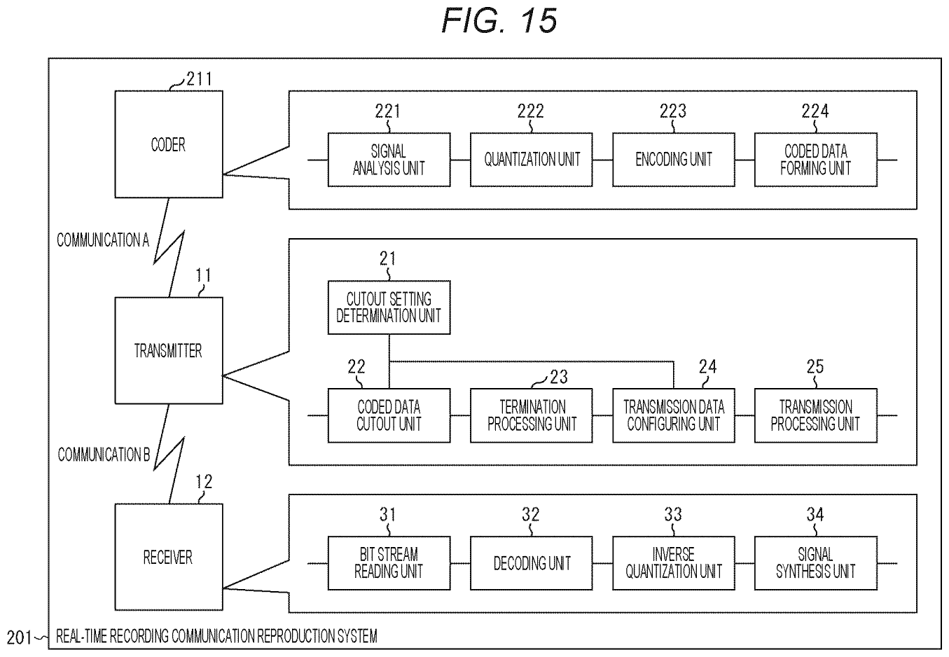

FIG. 15 is a diagram illustrating a configuration example of a real-time recording communication reproduction system according to a third embodiment of the present technology.

A real-time recording communication reproduction system 201 in FIG. 15 is different from the real-time communication reproduction system 1 in FIG. 4 in that a coder 211 is added.

That is, the real-time recording communication reproduction system 201 in FIG. 15 is configured to include the coder 211, and the transmitter 11 and the receiver 12 in FIG. 4. Note that, in FIG. 15, the same reference numerals are given to portions common to those in FIG. 4, and the description thereof will be omitted.

The coder 211 communicates with the transmitter 11 via communication A. The transmitter 11 communicates with the receiver 12 via communication B.

The coder 211 codes the audio signal input from the input system into coded data having the format of FIG. 2, and transmits the coded data to the transmitter 11 via the communication A.

Specifically, when receiving the communication start instruction, the coder 211 analyzes, quantizes, and codes the audio signal input from the input system, forms coded data in the format of FIG. 2, and transmits the coded data to the transmitter 11.

The transmitter 11 transmits at least part of the coded data to the receiver 12 according to the status of the communication B.

The receiver 12 receives at least part of the coded data and reproduces the same in real time.

Note that, in FIG. 15, unless otherwise specified, the communication A is a communication path having a sufficient band for communicating all coded data in real time, for example, communication in the same device, sufficiently high-speed Internet communication, or the like. The communication B is a communication path having no band sufficient for communicating all coded data in real time, for example, short-range communication such as Bluetooth.

Furthermore, in order to simplify the description, the coded data received via the communication A is temporarily stored in a storage area (not illustrated) of the transmitter 11. That is, the coder 211 and the transmitter 11 may be in the same device.

Furthermore, the data to be transmitted may be information such as video, audio, tactile sense, or vibration, but also in FIG. 15, audio data such as music will be described as an example.

Furthermore, in FIG. 15, it is assumed that an instruction to start or stop communication is exchanged among the coder 211, the transmitter 11, and the receiver 12.

Hereinafter, the configuration of the coder 211 will be described.

The coder 211 includes a signal analysis unit 221, a quantization unit 222, an encoding unit 223, and a coded data forming unit 224.

The signal analysis unit 221 performs band division and time-frequency conversion on the input audio signal from the input system for one frame, further analyzes the signal, and outputs the result to the quantization unit 222.

The band division includes, for example, a Quadrature Mirror Filter, a Polyphase Quadrature filter, or a ⅓ octave band analysis filter bank. The time-frequency transform may be, for example, a discrete Fourier transform or a modified discrete cosine transform (Modified Discrete Cosine Transform; MDCT).

The analysis includes, for example, envelope analysis of a time signal waveform, envelope analysis of a frequency spectrum, analysis of collecting the obtained frequency spectrum into a predetermined band, for example, a band of a critical bandwidth, and obtaining power of the spectrum for each collected band. Hereinafter, in order to simplify the description, the supplied signal is a frequency spectrum, but may be a time waveform signal or the like.

The quantization unit 222 quantizes the analyzed signal supplied from the signal analysis unit 221 and outputs the quantized signal to the coding unit 223. The quantization is performed, for example, by obtaining the maximum power of the frequency spectrum for each predetermined processing unit and calculating a coefficient (Scale Factor) such that the maximum value falls within +−1.

For example, in a case where the maximum value is 120, 128 that is a power of 2 is only required to be used as Scale Factor. The calculated Scale Factor is output to the coding unit 223 together with the quantized signal.

The coding unit 223 allocates a code to the quantized signal supplied from the quantization unit 222 according to a predetermined rule, and outputs the code to the coded data forming unit 224. Examples of codes used for encoding include Huffman codes and arithmetic codes.

The coded data forming unit 224 forms the supplied coded data in the format of FIG. 2 and outputs the coded data to a transmission processing unit (not illustrated). When the format is adjusted, the most significant bit is only required to be always set to 0 for every N bytes.

For example, in a case where N is 32 bytes and coded data is formed while being written out to the temporary storage area, the coded data forming unit 224 first sets the head bit to 0, and then writes out the header information, the sub-information, and the main information in this order until 32 bytes are reached. When 32 bytes are reached, the coded data forming unit 224 sets the head bit to 0, and subsequently writes out the remaining data. The above processing is repeated every 32 bytes.

### Processing of Coder

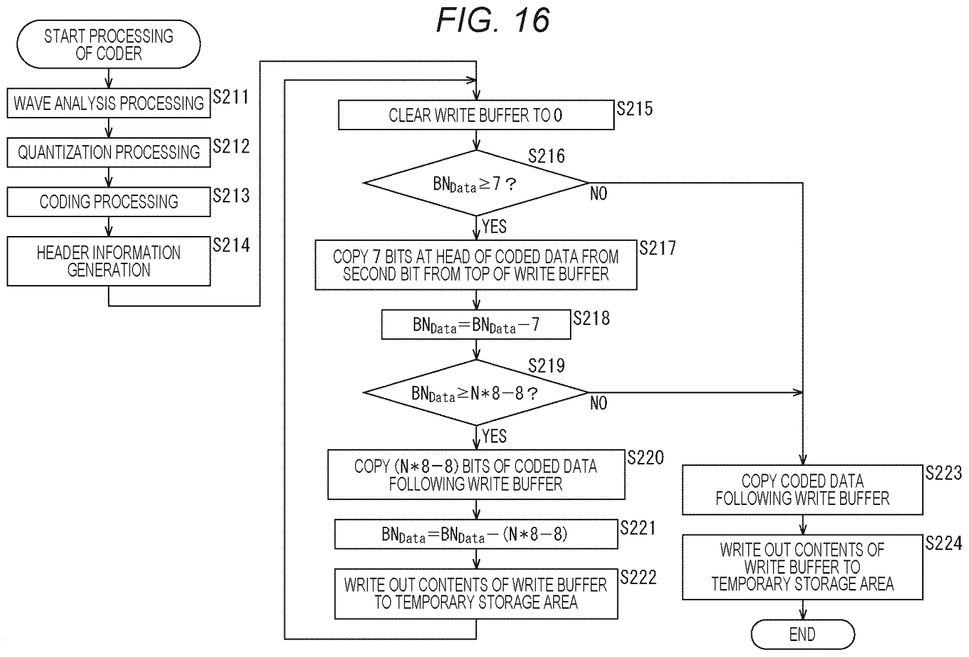

FIG. 16 is a flowchart illustrating processing of the coder 211.

In step S211, the signal analysis unit 221 performs waveform analysis on the audio signal of one frame.

In step S212, the quantization unit 222 quantizes the audio signal subjected to the waveform analysis.

In step S213, the coding unit 223 codes the quantized audio signal to generate coded data. The generated coded data is, for example, a bit string including sub-information and main information.

In step S214, the coded data forming unit 224 generates header information corresponding to the generated coded data. The frame size recorded in the header information is a value obtained by adding necessary 1 bit for each (N*8−1) bits in addition to the size of the generated coded data.

For example, it is calculated by the following formula (2).

$$\begin{matrix}[ Math . 2 ] & \\ Coded data total bit depth = Size of coded {data}^{*} 8 & ( 2 )\end{matrix}$$

$$Added bit depth = ( Integerization ) ( Coded data total bit depth ) / ( {N}^{*} 8 - 1 )$$

$$IF ( ( Coded data total bit depth + Added bit depth ) / There is reminder in ( {N}^{*} 8 ) )$$

$$THEN Added bit depth = Added bit depth + 1$$

$$Frame size = ROUNDUP ( ( Coded data total bit depth + Added bit depth ) / 8 )$$

$${*}^{} ROUNDUP is a function that integerizes the number by rounding up the decimal places .$$

Here, after step S215, the coded data forming unit 224 writes out the header information and the coded data to the temporary storage area while adding 0 bit for each (N*8−1) bit.

For this purpose, a write buffer having a size of N bytes is used. That is, the coded data forming unit 224 first clears the write buffer of N bytes to 0, copies coded data of (N*8−1) bits excluding the head bit, and writes out the copied coded data to the temporary storage area.

Note that the generated header information is assumed to be at the head of the coded data. Details will be described below.

In step S215, the coded data forming unit 224 clears the write buffer to 0.

In step S216, the coded data forming unit 224 determines whether or not the size (BN_{Data}) of the remaining coded data is 7 bits or more.

In a case where it is determined in step S216 that BN_{Data} is 7 bits or more, the processing proceeds to step S217.

In step S217, the coded data forming unit 224 copies the 7 bits at the head of the remaining coded data from the second bit from the top of the write buffer.

In step S218, the coded data forming unit 224 subtracts 7 bits obtained by copying BN_{Data} and updates the data.

In step S219, the coded data forming unit 224 determines whether or not BN_{Data} is larger than (N*8−8) bits. In a case where it is determined in step S219 that BN_{Data} is larger than (N*8−8) bits, the processing proceeds to step S220.

In step S220, the coded data forming unit 224 copies (N*8−8) bits of the remaining coded data following the 7 bits copied to the destination of the write buffer.

In step S221, the coded data forming unit 224 subtracts (N*8−8) bits to which BN_{Data} has been copied and updates BN_{Data}.

In step S222, the coded data forming unit 224 writes out the contents of the write buffer to the temporary storage area. After step S222, the processing returns to step S215, and the subsequent processing is repeated.

In a case where it is determined in step S216 that BN_{Data} is not 7 bits or more, or in a case where it is determined in step S219 that BN_{Data} is not (N*8−8) bits or more, the processing proceeds to step S223.

In step S223, the coded data forming unit 224 copies all the remaining coded data to the write buffer.

In step S224, the coded data forming unit 224 writes out the contents copied to the write buffer to the temporary storage area. Note that if there are no copied contents in the write buffer, nothing is performed.

After step S224, the processing of the coder 211 ends.

### 4. Fourth Embodiment

### Configuration of Real-Time Communication System

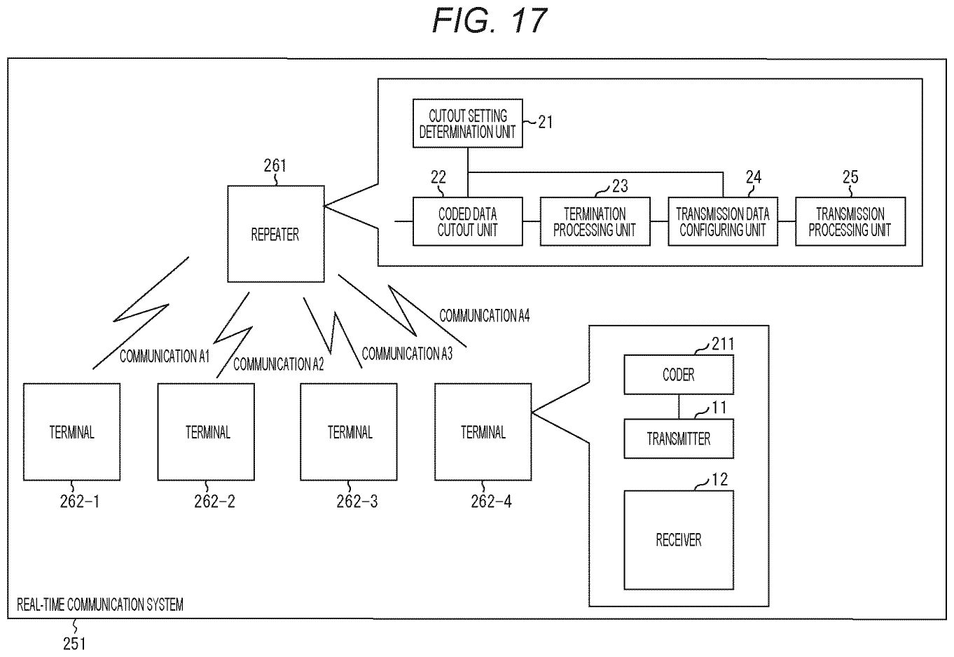

FIG. 17 is a block diagram illustrating a configuration example of a real-time communication system according to a fourth embodiment of the present technology.

A real-time communication system 251 in FIG. 17 includes one repeater 261 and four terminals 262-1 to 262-4 connected to the repeater 261 via the Internet or the like. Note that, in FIG. 17, the same reference numerals are given to portions common to those in FIG. 4 or 15, and the description thereof will be omitted. Note that the number of terminals may be two, three, or five or more.

The repeater 261 communicates with the terminals 262-1 to 262-4 via communications A1 to A4, respectively. In a case where it is not necessary to distinguish the terminals 262-1 to 262-4, they are referred to as terminals 262. In a case where it is not necessary to distinguish the communication A1 to A4, they are referred to as communication A.

The repeater 261 receives the coded data from at least one of the terminals 262, forms the coded data according to the communication status of the communication A with each terminal 262 to be transmitted, and transmits the formed coded data to each terminal 262.

In the real-time communication system 251 in FIG. 17, the communication status of each of the communications A1 to A4 changes from moment to moment. Therefore, for example, even if the terminal 262-1 transmits the coded data of a high bit rate to the repeater 261 due to the good communication status of the communication A1, in a case where the communication status of the communication A2 is bad, if the coded data is transmitted at a high bit rate, a failure such as interruption of sound may occur.

In the real-time communication system 251, it is possible to avoid occurrence of a failure by devising a method for transmitting coded data by the repeater 261 in such a status.

Furthermore, a configuration of each device will be described.

Similarly to the transmitter 11 in FIG. 4, the repeater 261 is configured to include a cutout setting determination unit 21, a coded data cutout unit 22, a termination processing unit 23, and a transmission data configuring unit 24.

When receiving the coded data from one of the terminals 262, the cutout setting determination unit 21 estimates the communication status of the communication A with each terminal 262, analyzes the status, and generates the cutout setting information for each terminal 262.

The coded data cutout unit 22 cuts out and generates coded data for one frame for each terminal 262.

The termination processing unit 23 performs termination processing on the generated coded data.

The transmission data configuring unit 24 collects data into a block to be transmitted at a time for each terminal 262 and outputs the data to the transmission processing unit 25. The data supplied to the transmission processing unit 25 is transmitted to each terminal 262.

The terminal 262 is configured to include a coder 211, a transmitter 11, and a receiver 12.

When an audio signal is input from the input system, the coder 211 forms coded data having the format of FIG. 2 and outputs the coded data to the transmitter 11.

The transmitter 11 collects the coded data formed by the coder 211 into a block of data to be transmitted at a time, and transmits the data to the repeater 261.

When receiving the coded data from the repeater 261, the receiver 12 synthesizes audio data and reproduces the audio data through a speaker or the like by an output system (not illustrated).

Note that, in FIG. 17, the coder 211 and the transmitter 11 are illustrated as separate blocks for simplicity of description, but may be combined into one block. In the case of being put together into one block, the coded data generated by the coder 211 may be adjusted so as to be within the size to be transmitted.

Furthermore, in FIG. 17, the repeater 261 transmits the received coded data to any terminal 262 without being distinguished from the terminal 262 that has transmitted the received coded data, but the received coded data may not be transmitted to the terminal 262 that has transmitted the coded data.

Furthermore, in a case where a plurality of pieces of coded data is received from a plurality of terminals 262 at substantially the same time, the repeater 261 may mix the plurality of pieces of coded data and then transmit the mixed coded data. In this case, for example, the cut coded data may be connected. Furthermore, in this case, a format in which coded data may be connected may be defined in advance.

Note that the processing of the repeater 261 and each terminal 262 can be realized by a configuration in which the processing described in the first to third embodiments is operated in a time division manner, and thus the description thereof will be omitted. The third and fourth embodiments are combined with the first embodiment, but may be combined with the second embodiment instead of the first embodiment.

### 5. Others

### Effects of Present Technology

As described above, in the present technology, coded data of one frame including header information and main information is cut out from a head of the header information at a cutout size that is an integral multiple of a unit of cutout of N bytes, and a terminal identifier is added to a terminal end of the cutout data.

According to the present technology, the bit rate adjustment according to the transmission band and the application can be completed by cutting out the data without decoding the coded data. Therefore, even if the content is stored as the coded data, the content can be distributed at a bit rate suitable for the communication path without increasing the processing amount.

Further, the quality of the recorded content can be maximized by transmitting the unsent coded data using the idle time of the communication. In particular, the quality of the recorded content can be maximized before the user knows.

Furthermore, in the real-time communication system, each terminal can transmit coded data at an optimum bit rate according to a communication status between each terminal and the repeater in the repeater without transmitting data coded at a plurality of bit rates.

### Configuration Example of Computer

The series of processing described above can be performed by hardware or by software. In a case where the series of processing is executed by software, a program included in the software is installed from a program recording medium on a computer incorporated in dedicated hardware, a general-purpose personal computer, or the like.

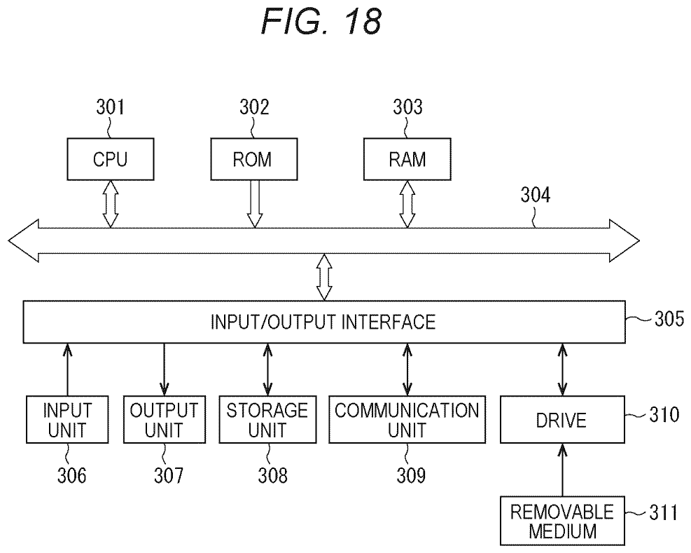

FIG. 18 is a block diagram illustrating a configuration example of the hardware of the computer that executes the series of processing described above in accordance with the program.

A CPU 301, a read only memory (ROM) 302, and a random access memory (RAM) 303 are mutually connected by a bus 304.

Moreover, to the bus 304, an input/output interface 305 is connected. An input unit 306 including a keyboard, a mouse, a microphone, and the like, and an output unit 307 including a display, a speaker, and the like are connected to the input/output interface 305. Furthermore, to the input/output interface 305, a storage unit 308 including a hard disk, a nonvolatile memory, and the like, a communication unit 309 including a network interface and the like, and a drive 310 that drives a removable medium 311 are connected.

In the computer configured as described above, the above-described series of processing steps is executed, for example, by the CPU 301 loading the program stored in the storage unit 308 into the RAM 303 via the input/output interface 305 and the bus 304 and executing the program.

The program executed by the CPU 301 is stored, for example, in the removable medium 311 and provided through a wired or wireless transmission medium such as a local area network, the Internet, or digital broadcasting, and installed in the storage unit 308.

Note that the program executed by the computer may be a program for processing in time series in the order described in the present description, or a program for processing in parallel or at a necessary timing such as when a call is made.

Note that, in the present specification, a system means an assembly of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both systems.

In addition, the effects described herein are merely examples and not restrictive, and there may also be other effects.

An embodiment of the present technology is not limited to the embodiments described above, and various modifications can be made without departing from the scope of the present technology.

For example, the present technology may be embodied as cloud computing in which one function is shared by a plurality of devices via a network and is processed in cooperation.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### Combination Example of Configuration

The present technology can also have the following configurations.
(1)
A signal processing device including:
a cutout unit that cuts out coded data of one frame including header information and main information from a head of the header information at a cutout size that is an integral multiple of a unit of cutout of N bytes; and
a termination processing unit that adds a terminal identifier to a terminal end of the cutout data cut out by the cutout unit.
(2)
The signal processing device according to (1), further including
a cutout size determination unit that determines the cutout size on a basis of at least one of a processing load on a transmission side, a communication status between a transmission side and a reception side, resource vacancy information on the reception side, a CPU usage rate on the reception side, and a remaining battery amount on the reception side.
(3)
The signal processing device according to (1) or (2), further including
a transmission unit that transmits the cutout data to which the terminal identifier is added.
(4)
the signal processing device according to (3), further including
a residual coded data configuring unit that generates residual coded data that is a remainder of the coded data after the cutout data is cut out by the cutout unit, in which
the transmission unit transmits the residual coded data.
(5)
The signal processing device according to (4), in which
the transmission unit transmits the residual coded data using an idle time of transmission of the cutout data.
(6)
The signal processing device according to (4) or (5), further including
a history information storage unit that stores history information of the cutout data cut out by the cutout unit, in which
the residual coded data configuring unit generates the residual coded data with reference to the history information.
(7)
The signal processing device according to (6), in which
the history information includes at least a frame number and the cutout size of the coded data.
(8)
The signal processing device according to any one of (1) to (7), in which
the unit of cutout is predetermined between a transmission side and a reception side, or is transmitted together with the cutout data to be shared between the transmission side and the reception side.
(9)
The signal processing device according to any one of (1) to (7), in which
the unit of cutout is changeable.
(10)
The signal processing device according to any one of (1) to (9), in which
in the cutout data, a first bit of the unit of cutout takes a first value, and a head bit of the terminal identifier takes a second value different from the first value.
(11)
The signal processing device according to any one of (1) to (10), in which
the header information includes a size of the coded data of the one frame.
(12)
The signal processing device according to any one of (1) to (11), in which
the coded data of the one frame includes the header information, sub-information, and the main information, and
the sub-information includes outline information of a signal to be restored.
(13)
The signal processing device according to (12), in which
the outline information includes at least one of information for restoring an envelope of a frequency spectrum and information for restoring an envelope of a time waveform.
(14)
The signal processing device according to any one of (1) to (13), in which
the information recorded in the main information is arranged in descending order of importance or ascending order from a head.
(15)
The signal processing device according to (14), in which
the information recorded in the main information is at least one of audio information, video information, tactile information, and vibration information, and is arranged in order from a head to a low frequency band to a high frequency band.
(16)
The signal processing device according to (14), in which
information recorded in the main information is hierarchical encoding information, and is arranged in order from a first layer from a head.
(17)
The signal processing device according to (14), in which
information recorded in the main information is at least any one of audio information, video information, tactile information, vibration information, and hierarchical encoding information, and in a case where the information is at least any one of audio information, video information, tactile information, and vibration information, the information is arranged in order from a low frequency band to a high frequency band from a head, and in a case where the information is hierarchical encoding information, the information is arranged in order from a first layer from a head.
(18)
A signal processing method including: by a signal processing device,
cutting out coded data of one frame including header information and main information from a head of the header information at a cutout size that is an integral multiple of a unit of cutout of N bytes; and
adding a terminal identifier to a terminal end of the cutout data.
(19)
A program for causing a computer to function as:
a cutout unit that cuts out coded data of one frame including header information and main information from a head of the header information at a cutout size that is an integral multiple of a unit of cutout of N bytes; and
a termination processing unit that adds a terminal identifier to a terminal end of the cutout data cut out by the cutout unit.
(20)
A signal processing device including
a decoding unit that decodes cutout data transmitted after coded data of one frame including header information and main information is cut out at a cutout size that is an integral multiple of a unit of cutout of N bytes from a head of the header information while detecting a terminal identifier added to a terminal end of the cutout data on the basis of a head bit of the cutout data, and decodes information that cannot be decoded when the terminal identifier is detected as zero.

### REFERENCE SIGNS LIST

1 Real-time communication reproduction system
11 Transmitter
12 Receiver
21 Cutout setting determination unit
22 Coded data cutout unit
23 Termination processing unit
24 Transmission data configuring unit
25 Transmission processing unit
31 Bit stream reading unit
32 Decoding unit
33 Inverse quantization unit
34 Signal synthesis unit
101 Real-time communication reproduction system
111 Transmitter
112 Receiver
121 Coded data cutout unit
122 Unsent coded data information storage unit
123 Residual coded data configuring unit
131 Received data sorting unit
132 Bit stream writing unit
201 Real-time recording communication reproduction system
211 Coder
221 Signal analysis unit
222 Quantization unit
223 Coding unit
224 Coded data forming unit
251 Real-time communication system
261 Repeater
262-1 to 262-4 Terminal

1. A signal processing device comprising:
a cutout unit that cuts out coded data of one frame including header information and main information from a head of the header information at a cutout size that is an integral multiple of a unit of cutout of N bytes; and
a termination processing unit that adds a terminal identifier to a terminal end of the cutout data cut out by the cutout unit.

2. The signal processing device according to claim 1, further comprising
a cutout size determination unit that determines the cutout size on a basis of at least one of a processing load on a transmission side, a communication status between a transmission side and a reception side, resource vacancy information on the reception side, a CPU usage rate on the reception side, and a remaining battery amount on the reception side.

3. The signal processing device according to claim 1, further comprising
a transmission unit that transmits the cutout data to which the terminal identifier is added.

4. The signal processing device according to claim 3, further comprising
a residual coded data configuring unit that generates residual coded data that is a remainder of the coded data after the cutout data is cut out by the cutout unit, wherein
the transmission unit transmits the residual coded data.

5. The signal processing device according to claim 4, wherein
the transmission unit transmits the residual coded data using an idle time of transmission of the cutout data.

6. The signal processing device according to claim 4, further comprising
a history information storage unit that stores history information of the cutout data cut out by the cutout unit, wherein
the residual coded data configuring unit generates the residual coded data with reference to the history information.

7. The signal processing device according to claim 6, wherein
the history information includes at least a frame number and the cutout size of the coded data.

8. The signal processing device according to claim 1, wherein
the unit of cutout is predetermined between a transmission side and a reception side, or is transmitted together with the cutout data to be shared between the transmission side and the reception side.

9. The signal processing device according to claim 1, wherein
the unit of cutout is changeable.

10. The signal processing device according to claim 1, wherein
in the cutout data, a first bit of the unit of cutout takes a first value, and a head bit of the terminal identifier takes a second value different from the first value.

11. The signal processing device according to claim 1, wherein
the header information includes a size of the coded data of the one frame.

12. The signal processing device according to claim 1, wherein
the coded data of the one frame includes the header information, sub-information, and the main information, and
the sub-information includes outline information of a signal to be restored.

13. The signal processing device according to claim 12, wherein
the outline information includes at least one of information for restoring an envelope of a frequency spectrum and information for restoring an envelope of a time waveform.

14. The signal processing device according to claim 1, wherein
information recorded in the main information is arranged in descending order of importance or ascending order from a head.

15. The signal processing device according to claim 14, wherein
the information recorded in the main information is at least one of audio information, video information, tactile information, and vibration information, and is arranged in order form a low frequency band to a high frequency band from a head.

16. The signal processing device according to claim 14, wherein
information recorded in the main information is hierarchical encoding information, and is arranged in order from a first layer from a head.

17. The signal processing device according to claim 14, wherein
information recorded in the main information is at least any one of audio information, video information, tactile information, vibration information, and hierarchical encoding information, and in a case where the information is at least any one of audio information, video information, tactile information, and vibration information, the information is arranged in order from a low frequency band to a high frequency band from a head, and in a case where the information is hierarchical encoding information, the information is arranged in order from a first layer from a head.

18. A signal processing method comprising: by a signal processing device,
cutting out coded data of one frame including header information and main information from a head of the header information at a cutout size that is an integral multiple of a unit of cutout of N bytes; and
adding a terminal identifier to a terminal end of the cutout data.

19. A program for causing a computer to function as:
a cutout unit that cuts out coded data of one frame including header information and main information from a head of the header information at a cutout size that is an integral multiple of a unit of cutout of N bytes; and
a termination processing unit that adds a terminal identifier to a terminal end of the cutout data cut out by the cutout unit.

20. A signal processing device comprising
a decoding unit that decodes cutout data transmitted after coded data of one frame including header information and main information is cut out at a cutout size that is an integral multiple of a unit of cutout of N bytes from a head of the header information while detecting a terminal identifier added to a terminal end of the cutout data on a basis of a head bit of the cutout data, and decodes information that cannot be decoded when the terminal identifier is detected as zero.
